(19) United States
(12) Patent Application Publication
(10) Pub. No.: US 2012/0250586 A1
(43) Pub. Date: Oct. 4, 2012

(54) METHODS AND APPARATUS FOR MANAGING DATA CONNECTIVITY

(76) Inventors: Kalle Ilmari AHMAVAARA, San Diego, CA (US); Vineet MITTAL, San Diego, CA (US)

(21) Appl. No.: 13/434,617

(22) Filed: Mar. 29, 2012

Related U.S. Application Data
(60) Provisional application No. 61/470,800, filed on Apr. 1, 2011.

(51) Int. Cl. H04W 4/26; H04W 12/00

(52) U.S. Cl. 370/259

(57) ABSTRACT

Methods and apparatus for data connectivity management may include detecting data associated with an application-specific connectivity account. The methods and apparatus may further include sending the detected data to a remote gateway configured to cause transmission of the data to be attributed to the application-specific connectivity account in response to detecting the data.

### CLAIM OF PRIORITY UNDER 35 U.S.C. §119

The present Application for patent claims priority to Provisional Application No. 61/470,800 entitled “Creating Service Specific Data Plans Paid by the Sponsor or the End Consumer” filed Apr. 1, 2011, and assigned to the assignee hereof and hereby expressly incorporated by reference herein.

### BACKGROUND

Wireless communication systems are widely deployed to provide various types of communication (e.g., voice, data, multimedia services, etc.) to multiple users. Further, such communication may be provided by a variety of sources. Users of mobile devices may run applications that receive communications from these various sources. In order to communicate data for the multiple applications with these various sources, a mobile device may communicate over several different wireless connections with an access node of a communication network.

For example, wireless connections may be associated with wireless communication systems that may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP2, 3GPP long-term evolution (LTE), LTE Advanced (LTE-A), etc. In addition, systems can conform to specifications such as WiFi or, more generally, any member of the IEEE 802.11 family of wireless protocols.

Depending on the type and/or location of the wireless connection and associated communication system used by a mobile device, fees may be charged for the use of the wireless connection for sending and receiving data. For example, when purchasing a cellular phone including data transfer capabilities beyond voice communication, a data plan may be purchased to allow internet connectivity, for example, over the cellular communications system. The fee charged may depend on the amount of data being transmitted over the wireless connection.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

One aspect relates to a method operable by a mobile device. The method may include detecting data associated with an application-specific connectivity account. In addition, the method may include in response to detecting the data associated with the application-specific connectivity account, sending the data to a remote network gateway configured to cause transmission of the data to be attributed to the application-specific connectivity account.

Another aspect relates to at least one processor. The processor may include a first module for detecting data associated with an application-specific connectivity account. The processor may also include in response to detecting the data associated with the application-specific connectivity account, a second module for sending the data to a remote network gateway configured to cause transmission of the data to be attributed to the application-specific connectivity account.

Another aspect relates to a computer program product. The computer program product may include a computer-readable medium including at least one instruction for causing a computer to detect data associated with an application-specific connectivity account. The computer-readable medium may also include in response to detecting the data associated with the application-specific connectivity account, at least one instruction for causing the computer to send the data to a remote network gateway configured to cause transmission of the data to be attributed to the application-specific connectivity account.

Yet another aspect relates to an apparatus. The apparatus may include means for detecting data associated with an application-specific connectivity account. The apparatus may further include in response to detecting the data associated with the application-specific connectivity account, means for sending the data to a remote network gateway configured to cause transmission of the data to be attributed to the application-specific connectivity account.

Another aspect relates to an apparatus. The apparatus may include a detecting component operable to detect data associated with an application-specific connectivity account. In addition, the apparatus may include a sending component operable to send the data to a remote network gateway configured to cause transmission of the data to be attributed to the application-specific connectivity account in response to detecting the data associated with the application-specific connectivity account.

Another aspect relates to a method operable by a network gateway. The method may include detecting data associated with an application-specific connectivity account. The method may also include in response to detecting the data associated with the application-specific connectivity account, allowing the detected data transfer to occur.

Another aspect relates to at least one processor. The processor may include a first module for detecting data associated with an application-specific connectivity account. The processor may also include in response to detecting the data associated with the application-specific connectivity account, a second module for allowing the detected data transfer to occur.

Still another aspect relates to a computer program product. The computer program product may include a computer-readable medium including at least one instruction for causing a computer to detect data associated with an application-specific connectivity account. In addition, the computer-readable medium may include in response to detecting the data associated with the application-specific connectivity account, at least one instruction for causing the computer to allow the detected data transfer to occur.

Another aspect relates to an apparatus. The apparatus may include means for detecting data associated with an application-specific connectivity account. The apparatus may also include in response to detecting the data associated with the application-specific connectivity account, means for allowing the detected data transfer to occur.

Yet another aspect relates to an apparatus. The apparatus may include a detecting component operable to detect data associated with an application-specific connectivity account. The apparatus may further include a data transfer component operable to allow the detected data transfer to occur in response to detecting the data associated with the application-specific connectivity account.

Another aspect relates to method of network communication. The method may include detecting an occurrence of an event, the detected event comprising a non-permitted use of the application-specific data connection. The method may also include preventing further transmission of the data via the application-specific data connection based on the occurrence of the detected event.

Another aspect relates to at least one processor. The processor may include a first module for detecting an occurrence of an event, the detected event comprising a non-permitted use of the application-specific data connection. The processor may further include a second module for preventing further transmission of the data via the application-specific data connection based on the occurrence of the detected event.

Still another aspect relates to a computer program product. The computer program product may include a computer-readable medium including at least one instruction for causing a computer to detect an occurrence of an event, the detected event comprising a non-permitted use of the application-specific data connection. The computer-readable medium may also include at least one instruction for causing the computer to prevent further transmission of the data via the application-specific data connection based on the occurrence of the detected event.

Another aspect relates to an apparatus. The apparatus may include means for detecting an occurrence of an event, the detected event comprising a non-permitted use of the application-specific data connection. In addition, the apparatus may include means for preventing further transmission of the data via the application-specific data connection based on the occurrence of the detected event.

Another aspect relates to an apparatus. The apparatus may include a data plan monitoring component operable to detect an occurrence of an event, the detected event comprising a non-permitted use of the application-specific data connection. The apparatus may further include a transmission component operable to prevent further transmission of the data via the application-specific data connection based on the occurrence of the detected event.

Yet another aspect relates to a method of network communication. The method may include exchanging application data over a sponsored application-specific data connection. In addition, the method may include triggering an incentive for the exchange of the application data via the sponsored application-specific data connection.

Another aspect relates to at least one processor. The processor may include a first module for exchanging application data over a sponsored application-specific data connection. The processor may further include a second module for triggering an incentive for the exchange of the application data via the sponsored application-specific data connection.

Another aspect relates to a computer program product. The computer program product may include a computer-readable medium including at least one instruction for causing a computer to exchange application data over a sponsored application-specific data connection. The computer-readable medium may also include at least one instruction for causing the computer to trigger an incentive for the exchange of the application data via the sponsored application-specific data connection.

Another aspect relates to an apparatus. The apparatus may include means for exchanging application data over a sponsored application-specific data connection. In addition, the apparatus may include means for triggering an incentive for the exchange of the application data via the sponsored application-specific data connection.

Another aspect relates to an apparatus. The apparatus may include a sending component operable to exchange application data over a sponsored application-specific data connection. The apparatus may additionally include an incentive component operable to trigger an incentive for the exchange of the application data via the sponsored application-specific data connection.

Still another aspect relates to a method for managing data connectivity. The method may include automatically switching between a use of an application-specific data connection and a use of a generic data connection for transmitting data.

Another aspect relates to at least one processor. The processor may include a first module for automatically switching between a use of an application-specific data connection and a use of a generic data connection for transmitting data.

Another aspect relates to a computer program product. The computer program product may include a computer-readable medium including at least one instruction for causing a computer to switch between a use of an application-specific data connection and a use of a generic data connection for transmitting data.

Another aspect relates to an apparatus including means for automatically switching between a use of an application-specific data connection and a use of a generic data connection for transmitting data.

Another aspect relates to an apparatus. The apparatus may include a switching component operable to automatically switch between a use of an application-specific data connection and a use of a generic data connection for transmitting data.

Yet another aspect relates to a method of network communication. The method may include receiving, at a network device, data transmitted from a mobile device as a result of the mobile device sending the data based on the data being associated with an application-specific connectivity account. The method may also include retrieving a data usage account associated with the mobile device, wherein the data usage account includes a data usage threshold. In addition, the method may include processing the received data based on the data usage threshold.

Another aspect relates to at least one processor. The processor may include a first module for receiving, at a network device, data transmitted from a mobile device as a result of the mobile device sending the data based on the data being associated with an application-specific connectivity account. In addition, the processor may include a second module for retrieving a data usage account associated with the mobile device, wherein the data usage account includes a data usage threshold. The processor may further include a third module for processing the received data based on the data usage threshold.

Another aspect relates to a computer program product. The computer program product may include a computer-readable medium including at least one instruction for causing a computer to receive, at a network device, data transmitted from a mobile device as a result of the mobile device sending the data based on the data being associated with an application-specific connectivity account. The computer-readable medium may also include at least one instruction for causing the computer to retrieve a data usage account associated with the mobile device, wherein the data usage account includes a data usage threshold. Moreover, the computer-readable medium may include at least one instruction for causing the computer to process the received data based on the data usage threshold.

Another aspect relates to an apparatus. The apparatus may include means for receiving, at a network device, data transmitted from a mobile device as a result of the mobile device sending the data based on the data being associated with an application-specific connectivity account. The apparatus may also include means for retrieving a data usage account associated with the mobile device, wherein the data usage account includes a data usage threshold. In addition, the apparatus may include means for processing the received data based on the data usage threshold.

Yet another aspect relates to an apparatus. The apparatus may include a receiving component operable to receive data transmitted from a mobile device as a result of the mobile device sending the data based on the data being associated with an application-specific connectivity account. In addition, the apparatus may include a data usage account component operable to retrieve a data usage account associated with the mobile device, wherein the data usage account includes a data usage threshold. The apparatus may further include a metering component operable to process the received data based on the data usage threshold.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is an illustration of a connectivity system in accordance with an aspect;

FIG. 2 is an illustration of an example application-specific connectivity account in accordance with another aspect;

FIG. 3 is an illustration of an example sending component and switching component in accordance with an aspect;

FIG. 4 is an illustration of an example receiving component in accordance with another aspect;

FIG. 5 is an illustration of an example data plan monitoring component in accordance with still another aspect;

FIG. 6 is an illustration of an example data usage account in accordance with yet another aspect;

FIG. 7 is a flow chart illustrating a method for managing data connectivity in accordance with an aspect;

FIG. 8 is a flow chart illustrating a method for switching data connections in accordance with another aspect;

FIG. 9 is a flow chart illustrating a method for managing data connectivity in accordance with yet another aspect;

FIG. 10 is a flow chart illustrating a method for providing sponsored data connectivity in accordance with an aspect;

FIG. 11 is a flow chart illustrating a method for managing data plans in accordance with still another aspect;

FIG. 12 is an example system that facilitates managing data connectivity in accordance with another aspect;

FIG. 13 is an example system that facilitates managing data connectivity in accordance with still another aspect;

FIG. 14 is an example system that facilitates providing sponsored data connectivity in accordance with an aspect;

FIG. 15 is an example system that facilitates switching data connections in accordance with an aspect;

FIG. 16 is an example system that facilitates managing data plans in accordance with yet another aspect;

FIG. 17 is an example mobile device operable within the connectivity system in accordance with an aspect;

FIG. 18 is server device operable within the connectivity system in accordance with yet another aspect;

FIG. 19 is an illustration of a connectivity system in accordance with an aspect;

FIG. 20 is an a flow chart illustrating a method for managing data connectivity in accordance with another aspect; and

FIG. 21 is an example system that facilitates managing data connectivity in accordance with an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details. The described aspects relate to methods and systems for managing data connectivity with a network for use with one or more applications on a mobile device. The methods and systems may allow a mobile device to manage data connectivity with the network in an ad hoc or on-demand fashion based upon the available data connections detected by the mobile device and the applications and/or service providers being accessed by the mobile device.

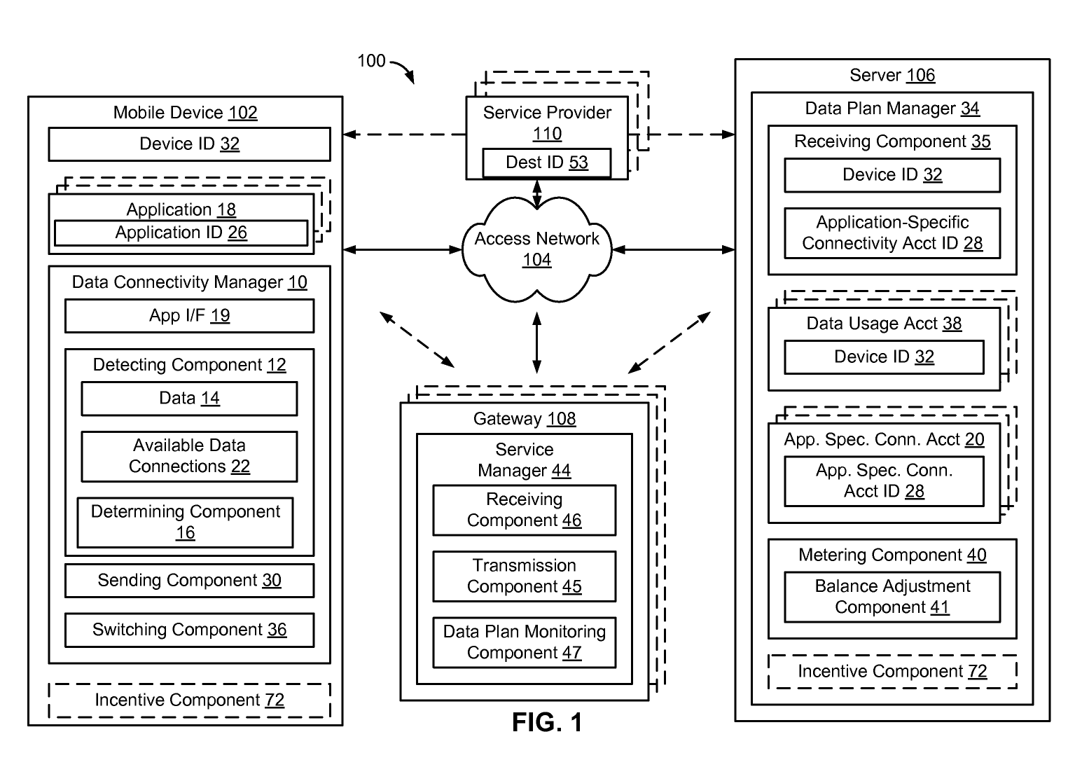

Referring now to FIG. 1, illustrated is an example connectivity system 100 that includes a mobile device 102 that is provided with an ability to establish a communication through an access network 104, such as to connect with a service provider 110, via a gateway 108 and/or a server/computing device 106 that manage the data connectivity. For example, in some aspects, mobile device 102 may include a wireless modem or other wireless communication interface capable of communicating on access network 104, however, mobile device 102 and/or wireless modem may not be a wireless network subscriber. Instead, in this example, mobile device 102 may be a subscriber to or otherwise have an account associated with server 106, which manages data connectivity to one or more networks, such as access network 104, in an ad hoc or on-demand fashion. Additionally, although for simplicity FIG. 1 only includes a single access network 104, a single server 106, a single gateway 108, and a single service provider 110, it should be understood that one or more of each of these entities may exist in system 100 and interact with mobile device 102.

Mobile device 102 may include a data connectivity manager 10 operable to detect data 14 for transmission, and determine that the detected data 14 is associated with an account, such as application-specific connectivity account 20, at server 106. Moreover, data connectivity manager 10 is further operable to identify one or more available data connections 22, and send the detected data 14 for transmission via one of the available data connections 22. For example, mobile device 102 may send the detected data 14 to gateway 108 so that gateway 108 can cause the transmission of the data 14 to an identified or derivable destination, such as service provider 110. For example, gateway 108 may include a service manager 44 operable to receive data 14 from mobile device 102, determine that the data 14 is associated with an account at server 106, such as application-specific connectivity account 20 or data usage account 38, and cause transmission of the data 14 based on the determined association. As such, the transmission of the data 14 may be controlled by and/or attributed to the application-specific connectivity account 20 or the data usage account 38 in order to track and/or manage communications to or from mobile device 102.

Mobile device 102 may include, but is not limited to, any type of client device or access terminal, such as any wireless, portable computing or communications device, such as a cellular device, that may connect to an access network 104. Mobile device 102 may be, for example, a cellular telephone, a navigation system, a computing device, a camera, a PDA, a music device, a gaming device or a handheld device having wireless connection capability, among other devices. Server/computing device 106 may include any mobile or fixed computing device connected to a network.

In addition, access network 104 may provide one or more types of communication connections, such as any type of wireless airlink or wired connection, to mobile device 102, gateway 108, server 106, and service provider 110. Mobile device 102 and gateway 108 may place and/or receive a communication via access network 104 to and/or from server 106 and/or service provider 110. As used herein, the term “communication” includes, but is not limited to, one or any combination of a voice call, a data call, a conference call, a video conferencing call, an Internet Protocol session, such as a SKYPE™ session, a Voice Over Internet protocol (IP) call, a short message service (SMS) message, a multimedia messaging service (MMS) message, an instant messaging (IM) service message, an electronic mail (e-mail) message, a chat or net-meeting related connection, a video, music, or data transfer, among other communications. In addition, mobile device 102 and gateway 108 may receive a communication via access network 104 from server 106 and/or service provider 110, or from any other device in communication with access network 104.

Server 106 includes any type of networked computing device having a data plan manager 34 configured to establish and monitor one or more application-specific connectivity accounts 20. Server 106 may be associated with an entity that provides data connectivity manager 10 to mobile device 102, and that provides gateway 108 on access network 104. As such, data plan manager 34 can use application-specific connectivity account 20 and gateway 108 to control transmission of data from mobile device 102.

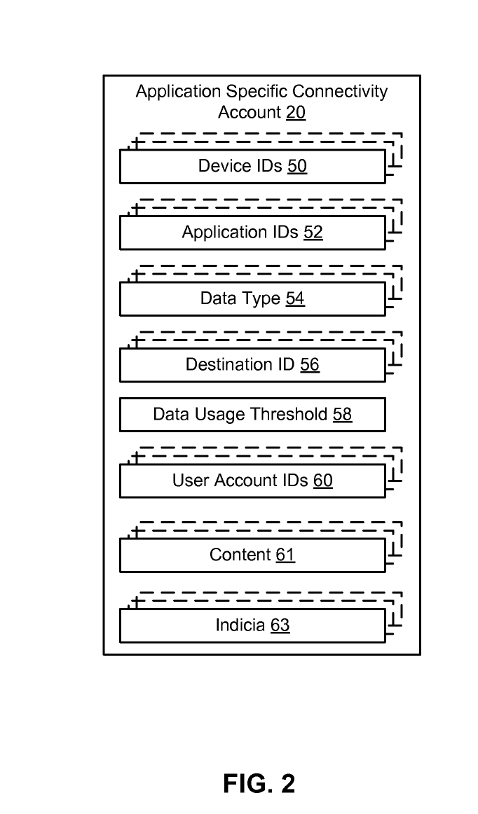

Referring to FIG. 2, in one aspect, application-specific connectivity account 20 may include one or more sets of information that can be used to manage and control data transmissions. For example, application-specific connectivity account 20 may have a plurality of device IDs 50 that are approved for using the application-specific connectivity account 20. In addition, the application-specific connectivity account 20 may also include a list of authorized application IDs 52 that are permitted to transmit data using the application-specific connectivity account 20 and/or authorized data types 54 that are permitted to be transmitted using the application-specific connectivity account 20. As such, in one aspect, the application-specific connectivity account 20 may specify that only data sent from a specific source, e.g., a music application having one of the authorized application IDs 52, may be transmitted using the application-specific connectivity account 20. Further, in another aspect, a particular type of data, e.g., e-mail messages, may be specified as an authorized data type 54 that may be sent using the application-specific connectivity account 20. The application-specific connectivity account 20 may further include authorized destination IDs 56 that correspond to authorized destinations, such as destination ID 53 of authorized service provider 110 or other entities on access network 104 (FIG. 1), to which data 14 can be transmitted. For example, authorized destination IDs 56 may include, but are not limited to, an IP address and a domain name. In addition, the application-specific connectivity account 20 may include a data usage threshold 58 which defines a limit to the amount of data that is capable of being transmitted using the application-specific connectivity account 20. For example, the data usage threshold 58 may only allow a specified number of bytes to be transferred during a time period. Further, the application-specific connectivity account 20 may include authorized user accounts IDs 60 that are approved for using the application-specific connectivity account 20. For example, the application-specific connectivity account 20 may require that a user register an account with the application-specific connectivity account 20 before allowing the user to transmit data using the application-specific connectivity account 20. Additionally, the application-specific connectivity account 20 may define permitted content 61 that may be transmitted in association with the application-specific connectivity account 20. For example, permitted content 61 may identify one or more content types or data payloads associated with a communication allowed under the application-specific connectivity account 20. Moreover, the application-specific connectivity account 20 may define one or more indicia 63 to identify the application-specific connectivity account 20 or data permitted for transmission under the account. For example, the indicia 63 may include a fingerprint representing the account or permitted data, a flag, a header, a code, or any other type of indicator. In addition, the indicia 63 may also include a pointer to gateway 108 (FIG. 1). In an aspect, the indicia 63 may point directly to gateway 108. The pointer may include, but is not limited to, an address (e.g., an IP address), a name (e.g., a domain name, such as a fully qualified domain name “FQDN”), or a uniform resource locator (URL), among other pointers to a gateway.

It should be noted that the above-noted parameters (e.g., permitted device IDs 50, permitted application IDs 52, permitted data types 54, permitted destination IDs 56, permitted data usage threshold 58, permitted user account IDs 60, permitted content 61, and indicia 63) defined by an application-specific connectivity account 20 for the transmission of data using the application-specific connection may dynamically change. For example, the application-specific connectivity account 20 may initially allow both image data and text data to be transmitted using the application-specific connection. However, as the frequency of data transmission increases and/or an available data usage balance diminishes, the application-specific connectivity account 20 may dynamically change the data type 54 that is allowed to be transmitted via the application-specific connection. For example, the application-specific connectivity account 20 may only allow text data to be transmitted instead of text data and image data.

Referring back to FIG. 1, in one aspect, data connectivity manager component 10 of mobile device 102 (FIG. 1) may include a detecting component 12 operable to detect data 14 for transmission and determine whether detected data 14 corresponds to application-specific connectivity account 20. For example, detecting component 12 may monitor for requests to transmit data from a plurality of applications 18 on or accessible to mobile device 102. Applications 18 may include, but are not limited to, e-mail services, web browsing services, social networking application services (e.g., Facebook™, Twitter™, LinkedIn™), VOIP services (e.g., SKYPE™), electronic book application services (e.g., Kindle™), music application services, video application services, among other applications that may allow or use some form of network connectivity. In an aspect, for example, data connectivity manager 10 may have an application interface 19 corresponding to the plurality of applications 18, which may be capable of being executed by mobile device 102 or which may be accessible to mobile device 102, such as via access network 104 (FIG. 1). As such, applications 18 may be specifically associated with or a part of data connectivity manager 10, or any other application resident on or accessible by mobile device 102. Accordingly, when a user executes an application 18 from the application interface 19, and application 18 generates data 14 for transmission, detecting component 12 may detect data 14 for transmission. In an aspect, for example, data 14 for transmission may include a data packet or any other format of a communication message, such as may be generated by mobile device 102 via execution of one of applications 18.

Detecting component 12 may include a determining component 16 configured to identify whether detected data 14 relates to one or more application-specific connectivity accounts 20. For example, determining component 16 is operable to analyze detected data 14, or information associated therewith, in order to find a match with respect to one or more parameters corresponding to each application-specific connectivity account 20. For example, determining component 16 compares detected data 14, or information associated therewith, for a match with one or more of permitted device IDs 50, permitted application IDs 52, permitted data types 54, permitted destination IDs 56, permitted data usage threshold 58, permitted user account IDs 60, permitted content 61, and indicia 63 (FIG. 2).

For example, in determining whether the detected data 14 is associated with an application-specific data account 20, determining component 16 may compare device ID 32 with the authorized device IDs 50 provided by the application-specific connectivity account 20 to determine if a match exists. If there is a match, determining component 16 may conclude that data 14 is associated with the corresponding application-specific connectivity account 20, and therefore that the detected data 14 is able to be transmitted in accordance with the application-specific connectivity account 20.

In another example, upon receiving notice of detected data 14, determining component 16 may obtain a source application ID 26 of the application 18 that generated data 14 for comparison with the authorized application IDs 52 provided by application-specific connectivity account 20. As a result, when there is a match between the source application ID 26 and one of the authorized application IDs 52, determining component 16 may decide that data 14 is associated with the corresponding application-specific connectivity account 20.

Alternatively, for example, determining component 16 may compare a type or characteristic or information included in data 14, with known data types and/or known data characteristics that correspond to the respective applications 18 to determine whether data 14 is associated with an application 18. In an aspect, data 14 may include one or more indicia that are configured to link or otherwise identify that data 14 corresponds to a given application 18. Indicia may include, but is not limited to, a fingerprint, a flag, a code, a certain bit having a certain value, an identifier, a header, etc., among other indicia that may link the data 14 to application 18.

Further, in a similar manner, determining component 16 respectively makes a comparison of a data type, a destination, an amount of data, a user account, content information, and/or indicia contained in or associated with detected data 14 to determine a match with a respective one of permitted data types 54, permitted destination IDs 56, permitted data usage threshold 58, permitted user account IDs 60, permitted content 61, and indicia 63 in order to determine whether detected data 14 corresponds to a respective application-specific connectivity account 20.

Detecting component 12 may also be operable to detect one or more available data connections 22. For example, in an aspect, available connection 22 may correspond to a signal received by mobile device 102, such as broadcast signals transmitted by an access point of access network 104 (FIG. 1) or any other network within range of mobile device 102. Available data connections 22 may include a generic data connection, such as WiFi. Generic data connections may include a free data connection and/or a paid data connection (e.g., a user of mobile device 102 pays for the data connection). In addition, available data connections 22 may include an application-specific connection corresponding to an application-specific connectivity account 20. Application-specific connectivity account 20 may correspond to certain applications 18 on mobile device 102 and/or to certain service providers 110. For example, an application-specific connectivity account 20 may include a SKYPE™ account that may have an application-specific connection that provides mobile device 102 with data connectivity to a network specifically for sending and/or receiving Voice over IP calls between registered users of the SKYPE™ account.

As such, mobile device 102 can detect data 14 for transmission, such as data generated by one of applications 18, and detect available data connections 22 that can be used to transmit detected data 14, thereby enabling mobile device 102 to access a network, such as access network 104, to provide application-specific connection to mobile device 102.

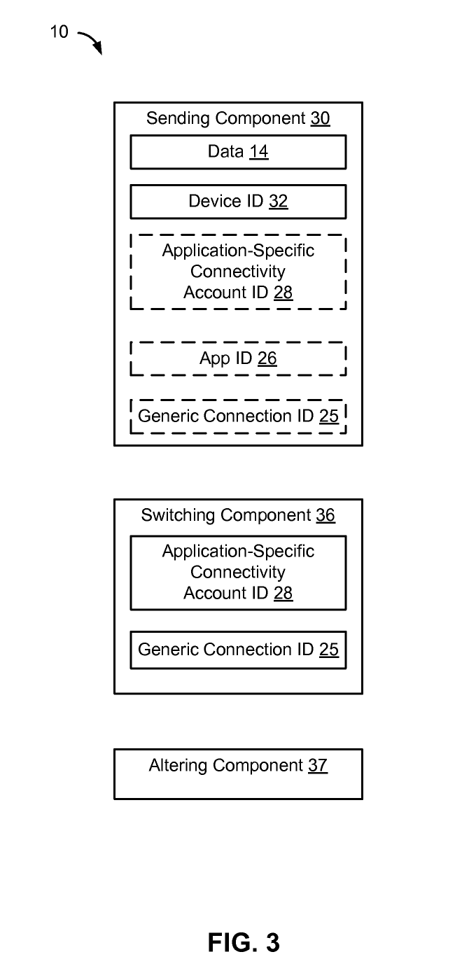

Referring additionally to FIG. 3, data connectivity manager 10 may further include a sending component 30 operable to send the detected data 14 to gateway 108 that is configured to cause transmission of the data 14 to the ultimate destination across access network 104, such as service provider 110. Sending component 30 may communicate with detecting component 12 and may identify the detected data 14 for transmission and/or identify corresponding available data connections 22. In addition, sending component 30 may communicate with determining component 16 to identify whether the detected data 14 is associated with an application-specific connectivity account 20 and/or an application 18.

In an aspect, if the detected data 14 is associated with an application-specific connectivity account 20, sending component 30 may send data 14 along with the corresponding device ID 32 and the application-specific connectivity account ID 28 to gateway 108 so that gateway 108 may cause the transmission of data 14 to be attributed to the application-specific connectivity account 20. For example, the application-specific connectivity account 20 may include indicia 63 (FIG. 2) that points directly to gateway 108 (e.g., an IP address, a FQDN, or a URL). In an aspect, sending component 30 may use the indicia 63 to identify gateway 108 and send data 14 to gateway 108. In addition, and/or in the alternative, if the detected data 14 is associated with a specific application 18, sending component 30 may send data 14 along with the device ID 32 and the application ID 26 to gateway 108 so that gateway 108 may cause the transmission of data 14 and attribute the transmission to the specific application 18, thereby indirectly attributing the transmission to a corresponding application-specific connectivity account 20.

In another aspect, if the sending component 30 is aware of one or more generic data connections identified by detecting component 12, then sending component 30 may send information of the generic data connection, such as a generic data connection ID 25, along with the data 14 and device ID 32 to gateway 108 so that gateway 108 may cause the transmission of data 14 via the generic data connection.

Data connectivity manager 10 may further include a switching component 36 operable to switch between using an application-specific connection and/or using a generic data connection to transmit the detected data 14. Switching component 36 may interface with detecting component 12 and determining component 16 to identify the available data connections 22 and utilize a respective one of the application-specific connection and/or the generic data connection. In an aspect, switching component 36 may apply one or more algorithms to determine which one of the available data connections 22 should be used to transmit data 14. Thus, switching component 36 may automatically switch between using an application-specific connection and a generic data connection by interfacing with the sending component 30 and forwarding the determined data connection to use for transmitting data 14.

One example algorithm may include automatically switching from using an application-specific connection to a generic data connection upon receiving an indication that the generic data connection is detected and available. For example, switching component 36 may receive a notification from detecting component 12 that a generic data connection has been detected, and the notification may include generic data connection ID 25. Upon receiving the notification of the generic data connection, switching component 36 may automatically switch from using the application specific connection to the generic data connection. Switching component 36 may interface with the sending component 30, by forwarding information identifying the generic data connection, such as a generic data connection ID 25, to sending component 30 so that the sending component 30 may forward the information identifying the generic data connection along with the data 14 to gateway 108 for transmission of the data 14 via the generic data connection.

Another algorithm may include switching from using a generic data connection to an application-specific connection based upon a reduction in a quality of service of the generic data connection.

Yet another algorithm may include switching from using a generic data connection to an application-specific connection when the generic data connection is a paid data connection and a data usage balance linked to the generic paid data connection is reduced. For example, if the amount of data available in the data usage balance is becoming low, switching component 36 may switch from using the generic data connection to an application-specific connection so that data 14 may continue to be transmitted before the data usage balance of the generic paid data connection is depleted. For example, switching component 36 may determine the data usage balance may be low when a user of mobile device 102 is prompted to purchase an additional data usage amount to increase the balance to enable continued use of the generic data connection. It should be appreciated that a variety of algorithms may be used to determine whether to switch between using the application-specific connection and one or more generic data connections.

In another aspect, switching component 36 may switch between using various application-specific connections associated with an application 18. For example, multiple application-specific connectivity accounts 20 may be associated with a single application. One application-specific connectivity account 20 may provide a high bandwidth application-specific data connection for the application 18, or a high bandwidth capable version of the application, while another application-specific connectivity account 20 may provide a low bandwidth application-specific data connection for the application 18, or a low bandwidth capable version of the application. Switching component 36 may switch between using the high bandwidth application-specific data connection and the low bandwidth application-specific data connection. Thus, mobile device 102 may dynamically connect to different versions of an application 18 based upon, for example, available bandwidth.

Data connectivity manager 10 may also include an altering component 37 operable to alter an operation of the application 18 that sent the detected data 14. For example, altering the operation of the application may include, but is not limited to, causing the application to refrain from downloading data, causing the application to alter a communication frequency, and causing the application to commence using data compression. In an aspect, the altering component 37 may alter the operation of the application 18 in response to using an application-specific data connection associated with the application 18. For instance, in an aspect, altering component 37 may include an algorithm that, upon detecting data from a given application, which may be an application that has been identified by data connectivity manager 10 as being subject to alteration (e.g., based on comparing actions to the parameters of the application-specific connectivity account 20, etc.), adjusts one or more settings at the application, at data connectivity manager 10, or at a communication component, such as a transmitter, associated with the above-noted refraining from downloading, altering of communication frequency, or using of data compression.

Referring back to FIG. 1, gateway 108 may include a service manager 44 operable to receive data for transmission from mobile device 102 and transmit the received data 14. Gateway 108 may be in communication with a plurality of service providers 110 and/or servers 106, and therefore, may be able to establish data connections with service provider 110 and/or server 106 to transmit the received data 14.

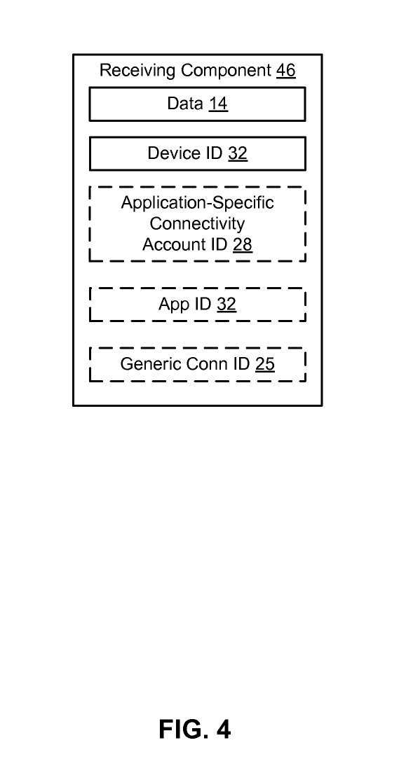

Referring now to FIG. 4, service manager 44 may have a receiving component 46 operable to receive data 14 and a device ID 32 sent from mobile device 102 (FIG. 1).

Receiving component 46 may also receive an application-specific connectivity account ID 28 and/or an application ID 26 that data 14 may be associated with. In an aspect, receiving component 46 may also receive a generic data connection ID 25 from mobile device 102.

Referring back to FIG. 1, service manager 44 may also have a transmission component 45 configured to transmit data to service providers 110 and/or servers 106 and transmits the received data 14. In an aspect, when receiving component 46 receives an application-specific connectivity account ID 28, transmission component 45 may identify the destination ID 53 associated with the service provider 110 for the application-specific connectivity account 20 and that provides the application-specific connection. For example, the application-specific connectivity account ID 28 may include an IP address or a domain name that corresponds to destination ID 53.

In addition, and/or alternatively, when receiving component 42 receives a generic data connection ID 25, transmission component 45 may provide access to the generic data connection specified by the generic data connection ID 25 and transmit data 14 using the generic data connection, e.g., via a WiFi data connection.

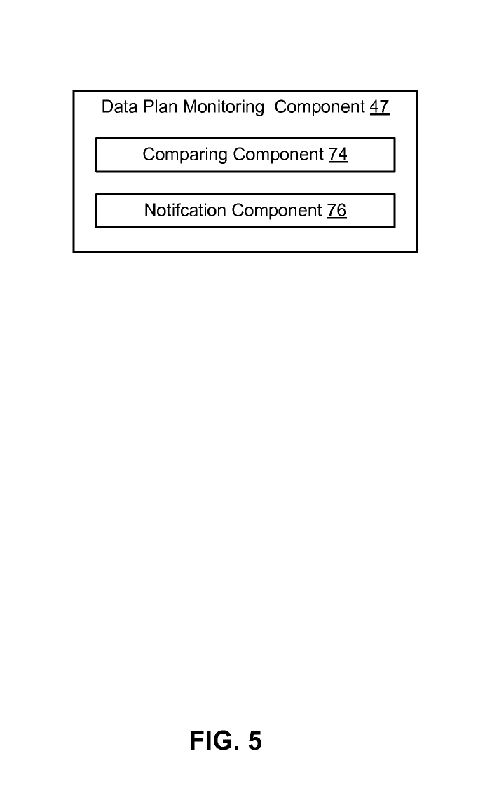

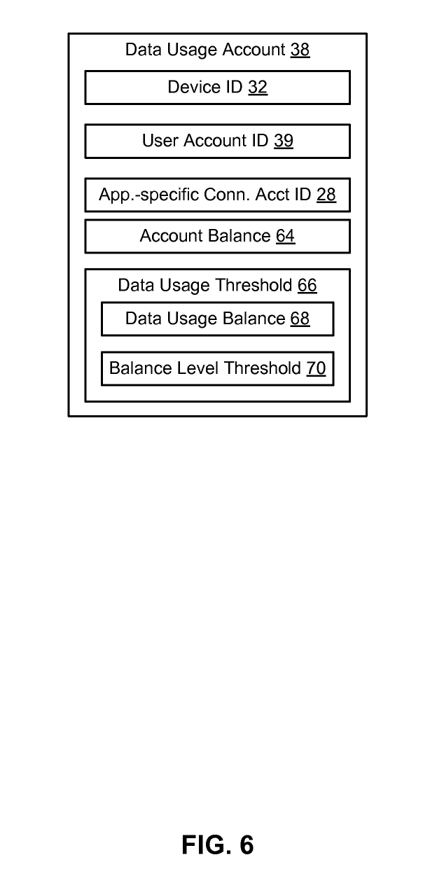

Referring to FIGS. 5 and 6, service manager 44 may also include a data plan monitoring component 47 that monitors and/or tracks data usage associated with a device ID 32 (FIG. 1) according to a data usage account 38. It should be noted that data usage account 38 may correspond to or include a user account ID 39, which may be one of permitted user account IDs 60 corresponding to application-specific connectivity account 20. Moreover, it should be noted that data plan monitoring component 47 may be a client-side component corresponding to a server-based data plan monitoring component, such as at server 106. Additionally, data usage account 38 may also correspond to a respective application-specific connectivity account 20, e.g., via an application-specific connectivity account ID 28, in order to track data usage associated with a device, user, or application with respect to an application-specific connection. In any case, data plan monitoring component 47 may include a comparing component 74 that compares the data usage with a data usage balance 68 associated with the device ID 32. In addition, data plan monitoring component 47 may have a notification component 76 that generates a notification when the data being transmitted exceeds an allocated data usage amount and/or does not match a parameter for transmission of data using the data connection.

In an aspect, when data 14 is associated with an application-specific connectivity account 20, comparing component 74 may compare the data being transmitted with the parameters specified by the application-specific connectivity account 20 and determine whether to allow the transmission of data 14. For example, comparing component 74 may determine whether the destination ID 53 associated with service provider 110 matches a destination ID 56 (FIG. 2) provided by the application-specific connectivity account 20. When comparing component 74 determines that the destination ID 53 matches a destination ID 56, notification component 76 may generate a notification indicating that the destination ID 53 is an approved destination. However, if destination ID 53 does not match a destination ID 56, notification component 76 may generate a notification indicating that the destination ID 53 is not an approved destination, and transmission component 45 may prevent transmission of data 14 based upon receiving the notification.

Moreover, comparing component 74 may compare an indicia of data 14 with the application-specific connectivity account 20 to ensure that the data transmitted using the application-specific connectivity account 20 is within the parameters of approved data. For example, comparing component 74 may compare a fingerprint of data 14 with a list of approved data fingerprints for using the application-specific connectivity account 20. If the fingerprint of data 14 does not match an approved data fingerprint, notification component 76 may generate a notification indicating that data 14 is not approved for transmission via the application-specific connectivity account 20. In another example, comparing component 74 may compare the amount of data 14 being transmitted with a data usage threshold 58 (FIG. 2) for the application-specific connectivity account 20. When the amount of data 14 being transmitted exceeds the data usage threshold 58, notification component 76 may generate a notification that the amount of data 14 being transmitted exceeds the data usage threshold 58.

Referring back to FIG. 1, data plan monitoring component 47 may communicate with transmission component 45 to prevent transmission of data 14. For example, when notification component 76 (FIG. 5) generates a notification that the data 14 does not comply with a parameter of an application-specific connectivity account 20, data plan monitoring component 47 may send the notification to transmission component 45. Transmission component 45 may receive the notification and prevent the transmission of data 14. For example, transmission component 45 may not establish a connection with the service provider 110 associated with the application-specific connectivity account 20. If the transmission component 45 has established an application-specific connection with service provider 110, transmission component 45 may prevent further transmission of data 14 via the application-specific connection. Thus, by monitoring the flow of data and comparing the data usage with previous usage patterns, selected data may be prevented and/or blocked from being transmitted.

Additionally, in an aspect, data plan monitoring component 47 may communicate with transmission component 45 to alter a data compression algorithm used to encode the data for transmission. For example, altering of the data compression algorithm may be based on usage or on network characteristics.

In an aspect, service manager 44 may interface with server 106 and may receive data usage account 38 associated with mobile device ID 32. It should be noted that service manager 44 may receive a plurality of data usage accounts 38 associated with mobile device ID 32. In addition, service manager 44 may receive an application-specific connectivity account 20 associated with data 14 from server 106.

Service manager 44 may use the received data usage accounts 38 and/or application-specific connectivity accounts 20 when determining whether to establish data connections with service providers 110 and/or generic data connections.

As noted above, server 106 may execute data plan manager 34 to store, track, and manage data usage accounts 38 associated with a mobile device 102. It should be noted that data plan manager 34 may store data usage accounts 38 for a plurality of mobile devices 102. In addition, server 106 may store and manage a plurality of application-specific connectivity accounts 20. Data plan manager 34 may have a receiving component 35 operable to receive one or more device IDs 32 from gateway 108 and/or mobile device 102. In addition, receiving component 35 may receive one or more application-specific connectivity account IDs from gateway 108 and/or mobile device 102. Data plan manager 34 may use the received device ID 32 to access the data usage account 38 associated with the device ID 32.

Referring now to FIGS. 1 and 6, data usage account 38 may include a device ID 32 associated with the data usage account 38. It should be noted that a mobile device may have more than one data usage account 38 associated with the mobile device. For example, a mobile device may have one data usage account for voice communications and a different data usage account for downloading videos.

Data usage account 38 may also include account balance 64, which may include a credit and/or monetary value for an amount of data that may be transmitted using the data usage account 38. The account balance 64 may correlate with data usage balance 68 which indicates the amount of data that may be transmitted based upon the account balance 64.

In addition, data usage account 38 may include a data usage threshold 66 operable to monitor the available data usage balance 68 for the data usage account 38. The data usage threshold 66 may compare the data usage balance 68 with a balance level threshold 70 to determine whether the data usage balance 68 is reaching the balance level threshold 70. In an aspect, the balance level threshold 70 may indicate when the data usage balance 68 should be replenished, e.g., an additional data usage amount added to the data usage balance 68. Thus, when the data usage balance 68 reaches the balance level threshold 70, an additional data usage amount may be added to the data usage balance 68 by, for example, adding an additional credit and/or monetary value to the account balance 64. The additional credit and/or monetary value may correlate to the amount of additional data usage to be added to the data usage balance 68.

Data plan manager 34 may also include a metering component 40 operable to meter the flow of data and compare the received data with the data usage balance 68. Metering component 40 may include a balance adjustment component 42 operable to adjust the account balance 64 and/or the data usage balance 68. For example, balance adjustment component 42 may decrease the data usage balance 68 as data is transmitted using the data usage account 38.

In addition, balance adjustment component 42 may increase the data usage balance 68 when an additional credit and/or a monetary value is added to the account balance 64. For example, a user of mobile device 102 may be prompted to purchase additional data connectivity. A user may select to purchase different types of data connectivity, such as e-mail data connectivity, voice over IP data connectivity, internet browsing, etc. It should be noted that different costs may be associated with different types of data connectivity. For example, the cost for purchasing internet browsing may be less than the cost for purchasing voice over IP data connectivity. In addition, a user may be prompted to purchase data connectivity for a specific application 18. In another aspect, a service provider 110 or other third party may be prompted to provide additional credits for the data connectivity.

In an optional aspect, mobile device 102 and/or server 106 may include an incentive component 72 operable to trigger an incentive for exchanging data via a sponsored application-specific data connection. A sponsored application-specific data connection may include, but is not limited to, a data connection that is subsidized (e.g., paid for, or partially paid for, by a third party, such as a service provider). Thus, a user of mobile device 102 may be able to use the sponsored application-specific data connection without having to purchase a data plan, e.g., free of charge and/or have a portion of the data connectivity paid for by a third party.

By subsidizing data connectivity, application service providers may be provided with an option for increasing revenue by providing a user with access to the application at all times without requiring the user to have an individual data connection plan for connecting to the network.

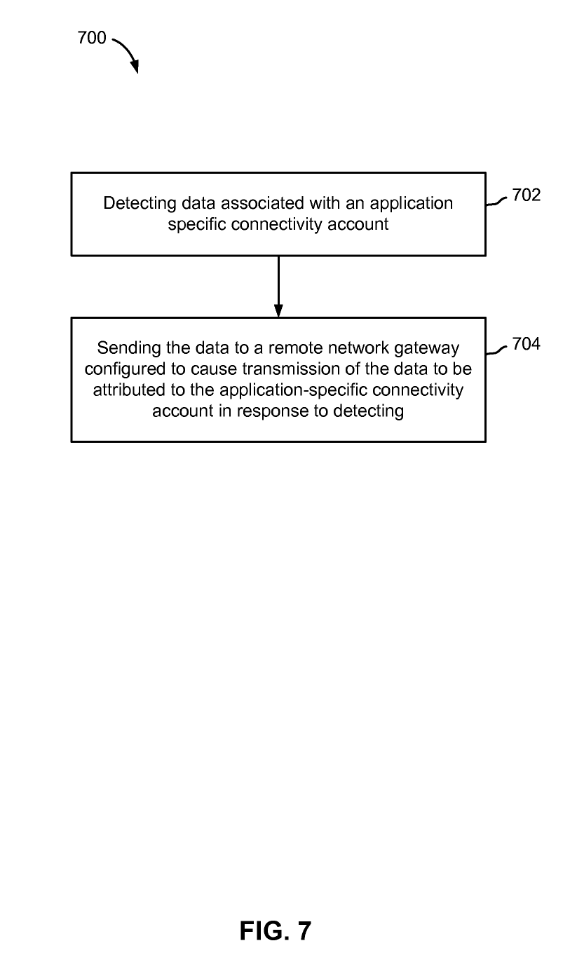

Referring now to FIG. 7, a method 700 for managing data connectivity in accordance with an aspect, includes at 702, detecting data associated with an application-specific connectivity account. For example, data connectivity manager 10 (FIG. 1) may have detecting component 12 (FIG. 1) that detects data 14 for transmission (FIG. 1) when an application 18 (FIG. 1) is executed. Data may include, but is not limited to, a data packet or any other format of communication message that may be generated when an application is executed.

Detecting component 12 may also detect that an application-specific connection is available. For example, mobile device 102 may have a receiver or a plurality of different technology receivers that are capable of listening for signals, such as broadcast signals transmitted by an access point of access network 104 (FIG. 1). When an application-specific connection is detected, detecting component 12 may also detect that an application-specific connectivity account 20 (FIG. 2) is associated with the application-specific connection.

Further, data connectivity manager 10 may have a determining component 16 (FIG. 1) that may determine whether the detected data 14 is associated with an application-specific connectivity account 20. The application-specific connectivity account 20 may correspond to an application 18. Determining component 16 may compare data 14, such as a type or characteristic thereof, with known data types and/or know data characteristics that correspond to application 18 to determine whether data 14 is associated with application 18, and therefore, associated with the application-specific connectivity account 20.

In an aspect, data 14 may include indicia, such as but not limited to, a fingerprint, a code, a certain bit having a certain value, an identifier, a header, a source identifier that is configured to link data 14 with application 18. Determining component 16 may detect and recognize the indicia of data 14, determine a relationship between the indicia and the application 18, and thereby linking data 14 to application 18. By linking data 14 to application 18, determining component 16 may determine that data 14 is associated with the application-specific connectivity account 20.

In an aspect, the application-specific connectivity account 20 may establish parameters for the transmission of data using the application-specific connectivity account 20. Parameters may include, but are not limited to, authorized device IDs 50, application IDs 52, data types 54, destination IDs 56, and user account IDs 60, permitted content 61, and indicia 63 (FIG. 2). Determining component 16 may compare the information within or associated with data 14 (e.g., source information and/or the fingerprint), and information associated with application 18 with the parameters of the application-specific connectivity account 20 to aid in determining whether data 14 is associated with the application-specific connectivity account 20.

At 704, the method may also include sending the data to a remote network gateway configured to cause transmission of the data to be attributed to the application-specific connectivity account in response to the detecting. In an aspect, in response to detecting that data 14 is associated with an application-specific connectivity account 20, data connectivity manager 10 may include a sending component 30 that may send data 14 to a remote network gateway 108 (FIG. 1) that is configured to cause transmission of the data to be attributed to the application-specific connectivity account 20. For example, gateway 108 may establish an application-specific data connection with a service provider 110 associated with the application-specific connectivity account 20 to transmit data 14 via the application-specific data connection.

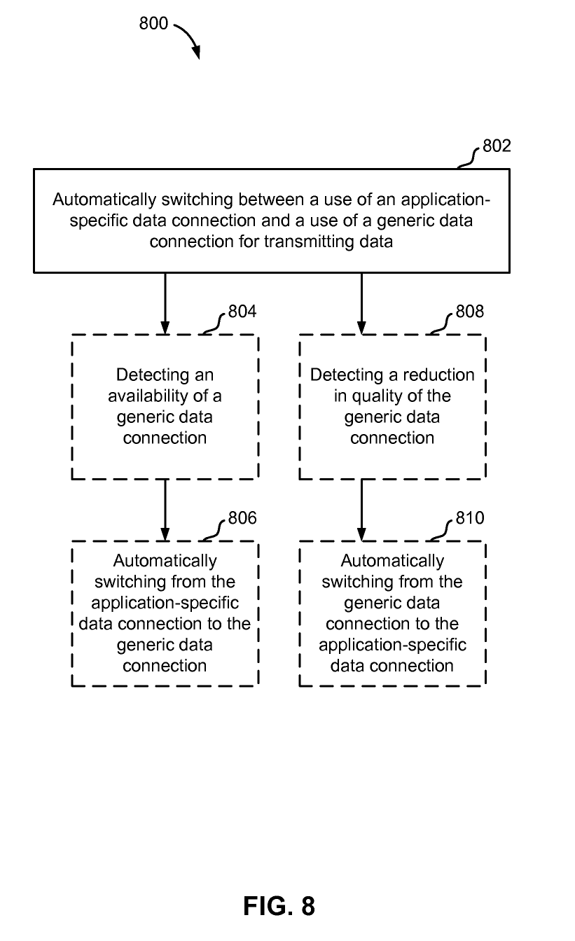

Referring now to FIG. 8, a method 800 for switching data connections in accordance with an aspect, includes, at 802, automatically switching between a use of an application-specific data connection and a use of a generic data connection for transmitting data. For example, mobile device 102 (FIG. 1) may have a switching component 36 (FIG. 1) that can switch between using an application-specific data connection and a generic data connection.

In an aspect, automatically switching between use of an application-specific data connection and use of a generic data connection may include switching from the use of the application-specific data connection to the use of the generic data connection. For example, when a data usage account 38 (FIG. 1) associated with the application-specific data connection is expended switching component 36 may switch from using the application-specific data connection to using a generic data connection.

The method may optionally include, at 804, detecting an availability of a generic data connection, and at 806, the method may include automatically switching from the generic data connection to the service-specific data connection when a generic data connection is detected. For example, a mobile device may detect that a generic data connection is available, e.g., a WiFi router. In an aspect, mobile device 102 (FIG. 1) may have a receiver or a plurality of different technology receivers that are capable of listening for signals, and when a generic data connection signal is detected, data connectivity manager 10 (FIG. 1) may automatically switch to using the detected generic data connection.

At 808, the method may optionally include, detecting a reduction in a quality of the generic data connection and, at 810, automatically switching from the generic data connection to the application-service specific data connection based upon the detection. For example, when mobile device 102 detects a reduction in the quality of service of the generic data connection, the data connectivity manager 10 may automatically switch from using the generic data connection to the application-specific connection. Quality of service reductions may include, but are not limited to, an increase in data delivery time (e.g., latency), a decrease in data through put, and dropped data packets, among other quality of service reductions.

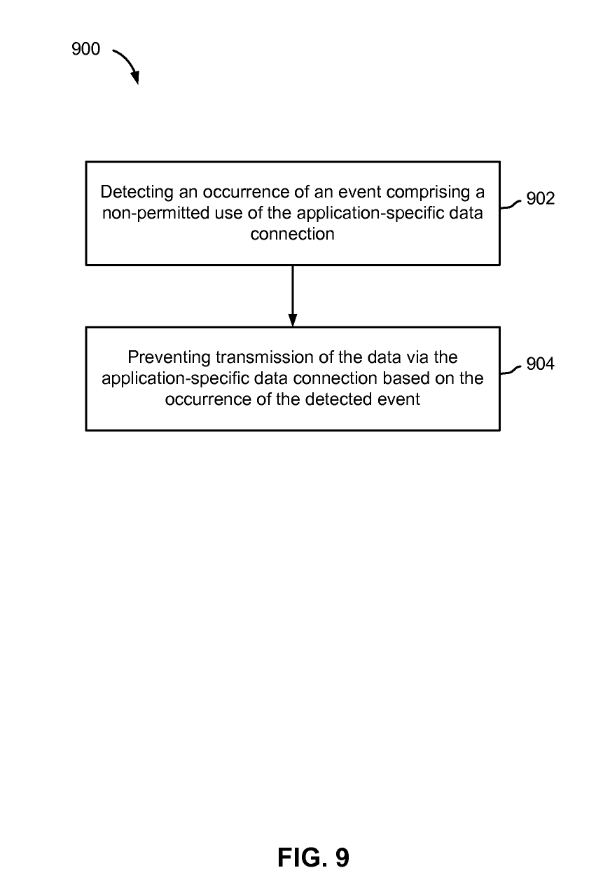

Referring now to FIG. 9, a method 900 for managing data connectivity in accordance with an aspect, includes at 902, detecting an occurrence of an event comprising a non-permitted use of the application-specific data connection. For example, a non-permitted use of the application-specific data connection may include transmitting data to a non-approved destination. Another non-permitted use of the application-specific data connection may include transmitting data in excess of an expected data usage amount for the typical data traffic of the application. In addition, a non-permitted use may include a fingerprint of the data not matching a set of approved fingerprints for data transmission.

For example, gateway 108 (FIG. 1) may have a data plan monitoring component 47 that monitors the flow of data 14 (FIG. 1) via the application-specific connection. Data plan monitoring component 47 may monitor the data flow and when an event occurs, such as an unexpected surge in data usage, data plan monitoring component 47 may generate a notification indicating that the event occurred. It should be noted that in addition to the above examples a variety of other non-permitted uses of the application-specific data connection may occur.

At 904, the method may include preventing transmission of the data via the application-specific data connection based on the occurrence of the detected event. In an aspect, gateway 108 may prevent the transmission of data 14 via the application-specific connection upon receiving a notification that detected event occurred. For example, if data plan monitoring component 47 generates a notification that a non-permitted use of the application-specific data connection occurred, gateway 108 may prevent the transmission of data 14 via the application-specific connection. By monitoring the data flow using the application-specific connection and comparing the data flow with typical data traffics and/or parameters for transmitting the data using the application-specific connection, the gateway may prevent improper use of the application-specific connection.

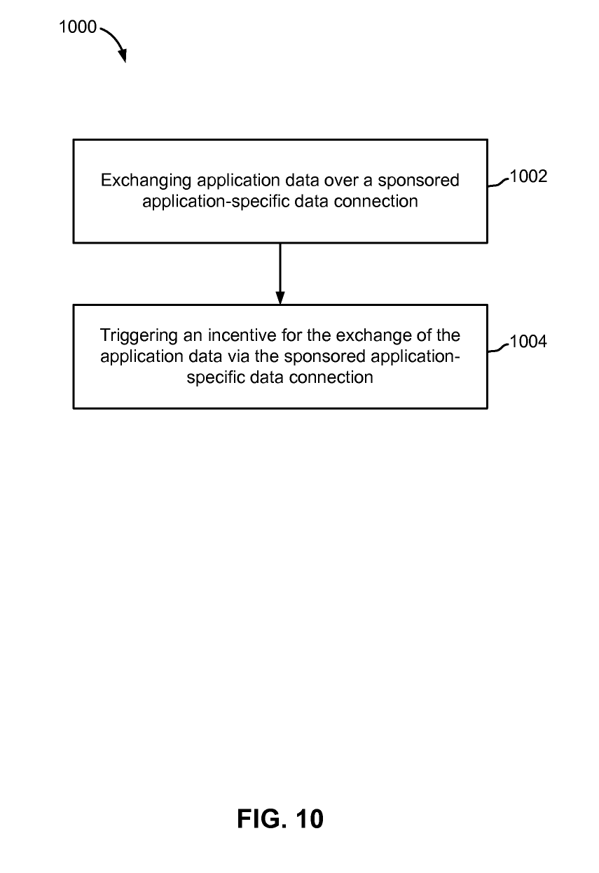

Referring now to FIG. 10, a method 1000 for providing sponsored data connectivity in accordance with an aspect includes, at 1002, exchanging application data over a sponsored application-specific data connection. A sponsored application-specific data connection may include, for example, a data connection that is paid for, or partially paid for, by a third party, such as a service provider.

In an aspect, service provider 110 (FIG. 1) may provide data connection free of charge so users of mobile device 102 can purchase and/or download items from a website associated with a game application. For example, a user may launch the game application 18 on mobile device 102 and service provider 110 may provide a sponsored data connection to a website associated with the game application 18 so the user can download and/or purchase games associated with the game application 18. It should be noted that when a user executes another application, such as an electronic book application, service provider 110 may not sponsor the data connection for the electronic book application, therefore mobile device 102 may need to establish data connection for the election book application as discussed above in regards to FIGS. 1-6.

At 1004, the method may include triggering an incentive for the exchange of the application data via the sponsored application-specific data connection. Incentives may include, but are not limited to, reduced data charges, additional data usage balances, providing promotions to purchase items using the sponsored application-specific data connection (e.g., providing a discount on a purchase of an electronic book, or giving away merchandise). For example, service provider 110 may provide incentives to users of mobile 102 to use the sponsored application-specific data connection. In addition, service provider 110 may provide incentives to gateway 108 to transmit data using the sponsored-data connection.

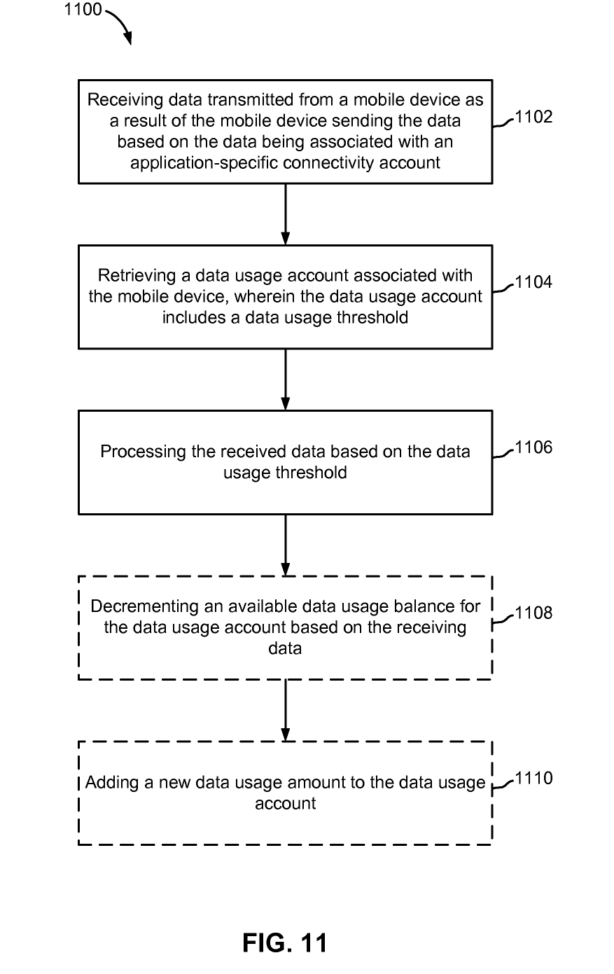

Referring now to FIG. 11, a method 1100 for managing data plans in accordance with an aspect includes, at 1102, receiving data transmitted from a mobile device as a result of the mobile device sending the data based on the data being associated with an application-specific data connectivity account. For example, server 106 (FIG. 1) may receive a device ID 32 (FIG. 1) associated with the mobile device 102 (FIG. 1) that transmitted data 14 (FIG. 1). In addition, server 106 may receive an application-specific connectivity account ID 22 for the application-specific data connectivity account 20 (FIG. 1) that data 14 is associated with.

At 1104, the method may include retrieving a data usage account associated with the mobile device, wherein the data usage account includes a data usage threshold. In an aspect, server 106 may retrieve a data usage account 38 associated with the device ID 32. The data usage account 38 may include a data usage threshold 66 (FIG. 6) with an available data usage balance 68 (FIG. 6) for transmitting data using the data usage account 38.

In addition, at 1106, the method may include processing the received data based on the data usage threshold. For example, server 106 may include a metering component 40 (FIG. 1) that meters the amount of data transmitted using the data usage account 38 and may compare the data usage balance 68 with the data usage threshold 66 to ensure the received data is within the data usage balance 68.

The method may optionally include, at 1108, decrementing an available data usage balance for the data usage account based on the received data. For example, metering component 40 include a balance adjustment component 41 that may decrease the available data usage balance 68 as data is transmitted using the data usage account 38.

The method may also optionally include, at 1110, adding a new data usage amount to the data usage account. For example, metering component 40 may include a balance adjustment component 41 may add additional data usage amounts to the available data usage balance 68. In an aspect, metering component 40 may determine that the available data usage balance 68 may be approaching the data usage threshold 70 and may prompt the balance adjustment component 41 to add an additional data usage amount to the available data usage balance 68. For example, a user of mobile device 102 may be prompted to provide a monetary value equivalent to the additional data usage amount. In addition, and/or alternatively, if the connection is a sponsored data connection, a service provider or third party may be prompted to provide additional credits equivalent to the additional data usage amount.

Thus, the data plans associated with a mobile device and/or an application-specific connectivity account may be dynamically changed as data is transmitted. For example, a user of a mobile device may be able to pay for additional data connectivity as an available data usage balance is depleted. Moreover, as an available data balance is depleted, the mobile device may select to use an application-specific connectivity account and/or a generic data connection. Therefore, users may have an ad hoc or on-demand data connection to one or more networks based upon the data plans the user purchases and/or data connections accessed by the mobile device. As such, applications may be accessed at anytime or in any location while also providing cost savings for specific applications.

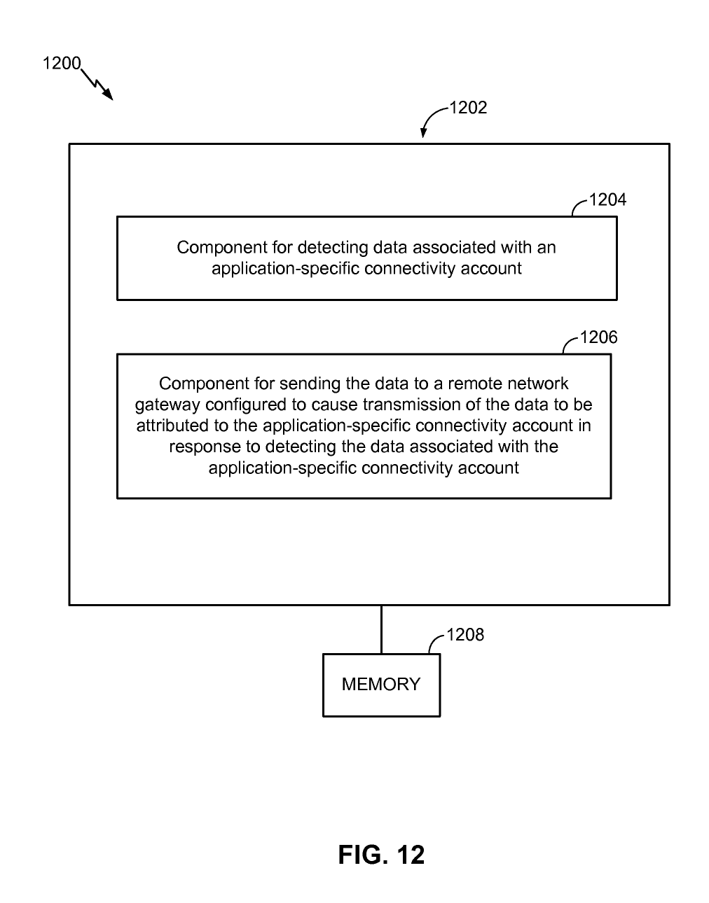

Referring now to FIG. 12, illustrated is a system 1200 configured for data connectivity management. For example, system 1200 can reside at least partially within a transmitter, mobile device, etc. It is to be appreciated that system 1200 is represented as including functional blocks, which can be functional blocks that represent functions implemented by a processor, software, or combination thereof (e.g., firmware). System 1200 includes a logical grouping 1202 of electrical components that facilitate data connectivity management. For instance, logical grouping 1202 may include component 1204 for detecting data associated with an application-specific connectivity account. Further, logical grouping 1202 may comprise component 1206 for sending the data to a remote network gateway configured to cause transmission of the data to be attributed to the application-specific connectivity account in response to detecting the data associated with the application-specific connectivity account. Additionally, system 1200 can include a memory 1208 that retains instructions for executing functions associated with electrical components 1204 and 1206. While shown as being external to memory 1208, it is to be understood that one or more of electrical components 1204 and 1206 can exist within memory 1208.

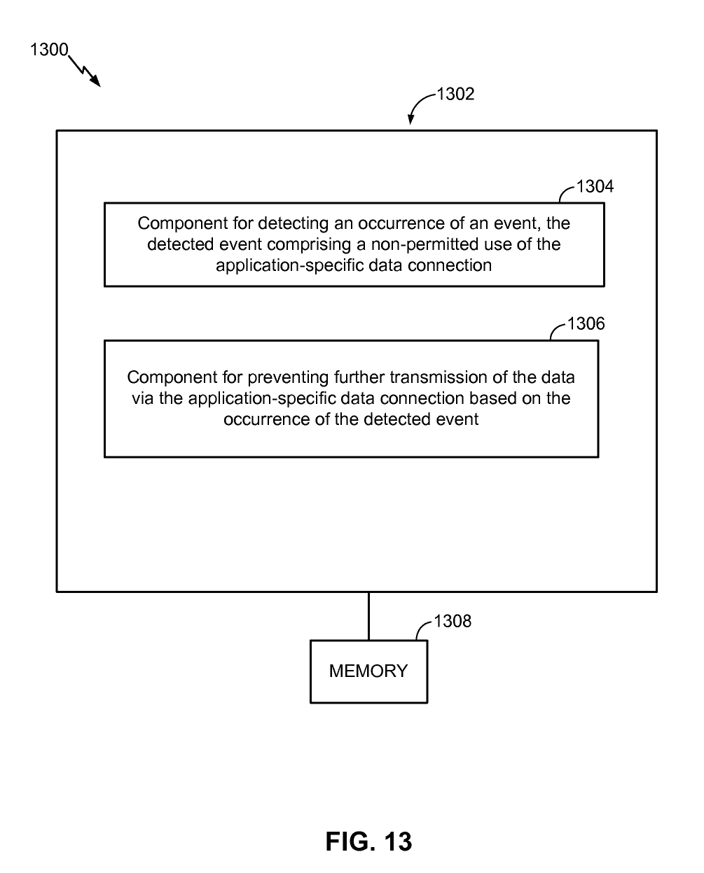

Referring now to FIG. 13, illustrated is a system 1300 configured for data connectivity management. For example, system 1300 can reside at least partially within a transmitter, mobile device, etc. It is to be appreciated that system 1300 is represented as including functional blocks, which can be functional blocks that represent functions implemented by a processor, software, or combination thereof (e.g., firmware). System 1300 includes a logical grouping 1302 of electrical components that facilitate data connectivity management. For instance, logical grouping 1302 may include component 1304 for detecting an occurrence of an event, the detected event comprising a non-permitted use of the application-specific data connection. Further, logical grouping 1302 may comprise component 1306 for preventing further transmission of the data via the application-specific data connection based on the occurrence of the detected event. Additionally, system 1300 can include a memory 1308 that retains instructions for executing functions associated with electrical components 1304 and 1306. While shown as being external to memory 1308, it is to be understood that one or more of electrical components 1304 and 1306 can exist within memory 1308.

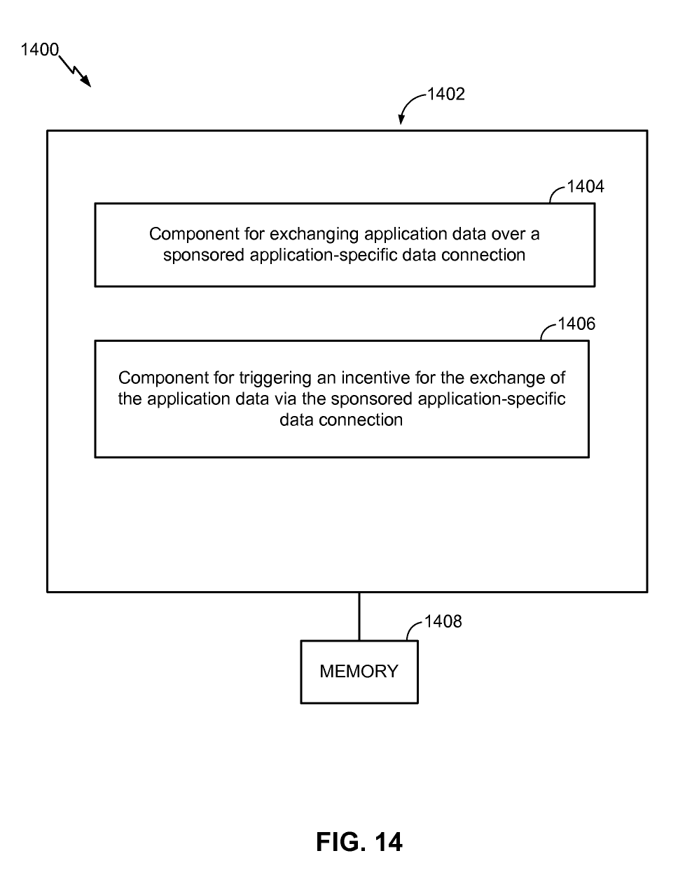

Referring now to FIG. 14, illustrated is a system 1400 configured for providing sponsored data connectivity. For example, system 1400 can reside at least partially within a transmitter, mobile device, etc. It is to be appreciated that system 1400 is represented as including functional blocks, which can be functional blocks that represent functions implemented by a processor, software, or combination thereof (e.g., firmware). System 1400 includes a logical grouping 1402 of electrical components that facilitate providing sponsored data connectivity. For instance, logical grouping 1402 may include component 1404 for exchanging application data over a sponsored application-specific data connection. Further, logical grouping 1402 may comprise component 1406 for triggering an incentive for the exchange of the application data via the sponsored application-specific data connection. Additionally, system 1400 can include a memory 1408 that retains instructions for executing functions associated with electrical components 1404 and 1406. While shown as being external to memory 1408, it is to be understood that one or more of electrical components 1404 and 1406 can exist within memory 1408.

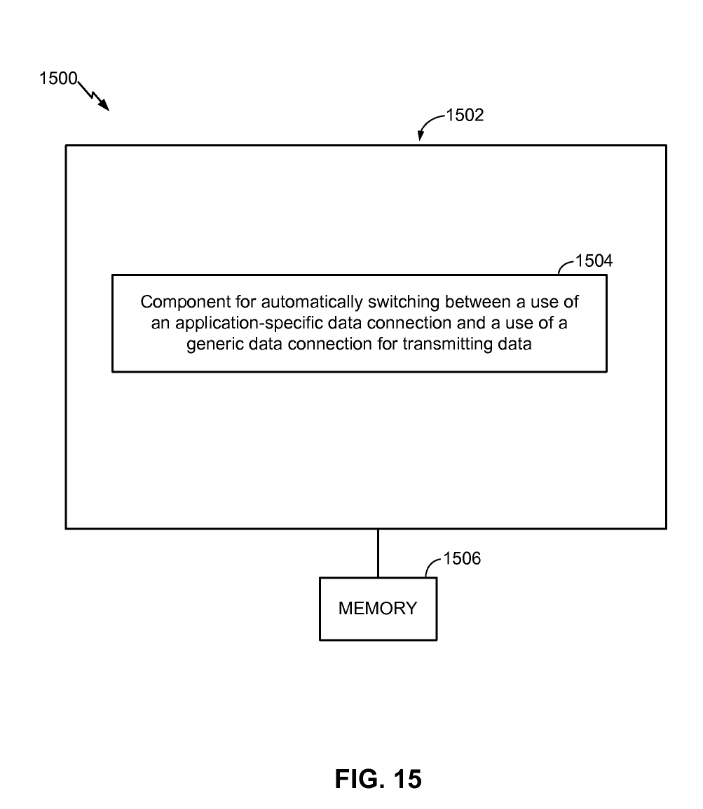

Referring now to FIG. 15, illustrated is a system 1500 configured for switching data connections. For example, system 1500 can reside at least partially within a transmitter, mobile device, etc. It is to be appreciated that system 1500 is represented as including functional blocks, which can be functional blocks that represent functions implemented by a processor, software, or combination thereof (e.g., firmware). System 1500 includes a logical grouping 1502 of electrical components that facilitate switching data connections. For instance, logical grouping 1502 may include component 1504 for automatically switching between a use of an application-specific data connection and a use of a generic data connection for transmitting data. Additionally, system 1500 can include a memory 1504 that retains instructions for executing functions associated with electrical component 1504. While shown as being external to memory 1504, it is to be understood that electrical component 1504 can exist within memory 1504.

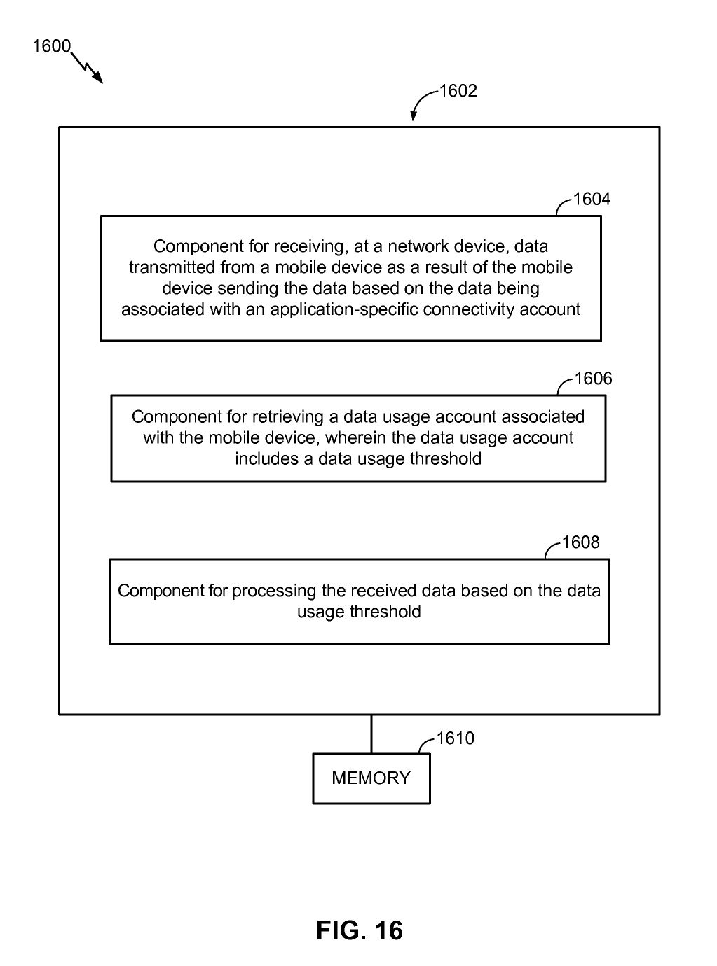

Referring now to FIG. 16, illustrated is a system 1600 configured for managing data plans. For example, system 1600 can reside at least partially within a transmitter, mobile device, etc. It is to be appreciated that system 1600 is represented as including functional blocks, which can be functional blocks that represent functions implemented by a processor, software, or combination thereof (e.g., firmware). System 1600 includes a logical grouping 1602 of electrical components that facilitate managing data plans. For instance, logical grouping 1602 may include component 1604 for receiving, at a network device, data transmitted from a mobile device as a result of the mobile device sending the data based on the data being associated with an application-specific connectivity account. Further, logical grouping 1602 may comprise component 1606 for retrieving a data usage account associated with the mobile device, wherein the data usage account includes a data usage threshold. Logical grouping 1602 may also comprise component 1608 for processing the received data based on the data usage threshold. Additionally, system 1600 can include a memory 1610 that retains instructions for executing functions associated with electrical components 1604, 1606, and 1608. While shown as being external to memory 1610, it is to be understood that one or more of electrical components 1604, 1606, and 1608 can exist within memory 1610.

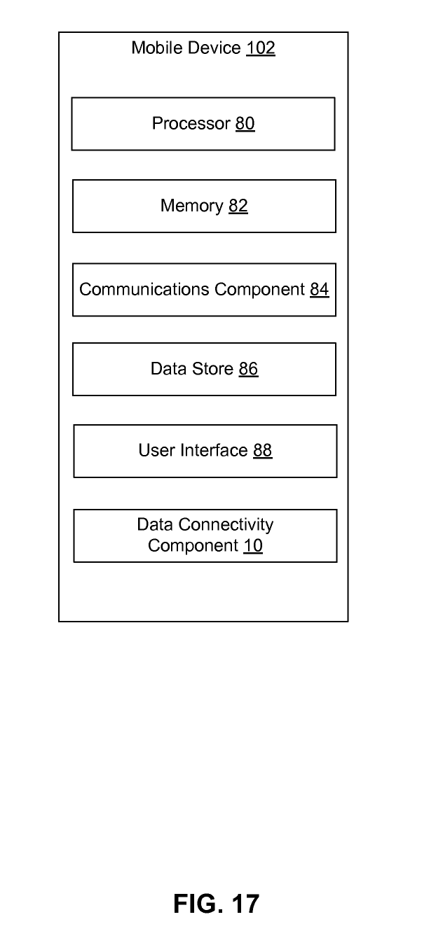

Referring now to FIG. 17, illustrated is an example mobile device 102 operable within the connectivity system in accordance with an aspect. In one aspect, mobile device 102 may include a processor 80 for carrying out processing functions associated with one or more of components and functions described herein. Processor 80 can include a single or multiple set of processors or multi-core processors. Moreover, processor 80 can be implemented as an integrated processing system and/or a distributed processing system.

Mobile device 102 may further includes a memory 82, such as for storing local versions of applications being executed by processor 80. Memory 82 can include a type of memory usable by a computer, such as random access memory (RAM), read only memory (ROM), tapes, magnetic discs, optical discs, volatile memory, non-volatile memory, and any combination thereof.

Further, mobile device 102 includes a communications component 84 that provides for establishing and maintaining communications with one or more parties utilizing hardware, software, and services as described herein. Communications component 84 may carry communications between components on mobile device 102, as well as between mobile device 102 and external devices, such as devices located across a communications network and/or devices serially or locally connected to mobile device 102. For example, communications component 84 may include one or more buses, and may further include transmit chain components and receive chain components associated with a transmitter and receiver, respectively, operable for interfacing with external devices.

Additionally, mobile device 102 may further include a data store 86, which can be any suitable combination of hardware and/or software, that provides for mass storage of information, databases, and programs employed in connection with aspects described herein. For example, data store 86 may be a data repository for applications not currently being executed by processor 80.

Mobile device 102 may additionally include a user interface component 88 operable to receive inputs from a user of mobile device 102 and further operable to generate outputs for presentation to the user. User interface component 88 may include one or more input devices, including but not limited to a keyboard, a number pad, a mouse, a touch-sensitive display, a navigation key, a function key, a microphone, a voice recognition component, any other mechanism capable of receiving an input from a user, or any combination thereof. Further, user interface component 88 may include one or more output devices, including but not limited to a display, a speaker, a haptic feedback mechanism, a printer, any other mechanism capable of presenting an output to a user, or any combination thereof.

Mobile device 102 may also include a data connectivity manager 10 (FIG. 1). In an aspect, user interface component 88 may transmit and/or receive messages corresponding to the operation of data connectivity manager 10. In addition, processor 80 executes data connectivity manager 10 and memory 82 or data store 86 may store them.

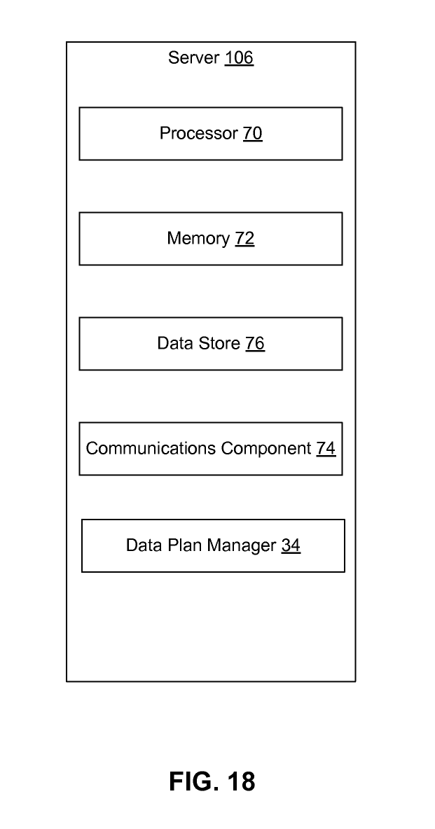

Referring now to FIG. 18, illustrated is an example sever device 106 operable within the connectivity system in accordance with yet another aspect. Server 106 manages network connectivity matters for access network 104. Server 106 includes processor component 70 for carrying out processing functions associated with one or more of components and functions described herein. Processor component 70 can include a single or multiple set of processors or multi-core processors. Moreover, processing component 70 can be implemented as an integrated processing system and/or a distributed processing system.

Server 106 further includes a memory 72, such as for storing local versions of applications being executed by processor component 70. Memory 72 can include random access memory (RAM), read only memory (ROM), and a combination thereof.

Further, server 106 includes a communications component 74 that provides for establishing and maintaining communications with one or more parties utilizing hardware, software, and services as described herein. Communications component 74 may carry communications between components on server 106, as well as between server 106 and external devices, such as devices located across a communications network and/or devices serially or locally connected to server 106.

Additionally, server 106 may further include a data store 76, which can be any suitable combination of hardware and/or software, that provides for mass storage of information, databases, and programs employed in connection with aspects described herein. For example, data store 76 may be a data repository for applications not currently executing.

Server 106 may also include data plan manager 34 (FIG. 1). In an aspect, communications component 74 may transmit and/or receive messages corresponding to the operation of data plan manager 34. In addition, processor 70 may execute data plan manager 34, and memory 72 may store them.

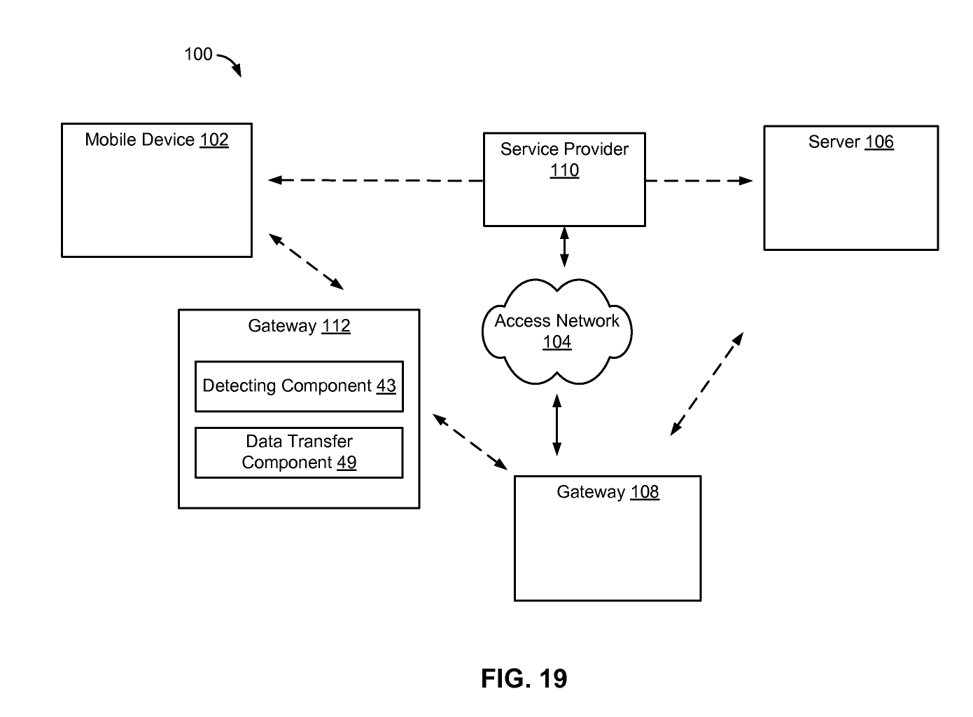

Referring now to FIG. 19, in one variation, communication system 100 may include an additional gateway 112 in communication with mobile device 102 and gateway 108. In an aspect, gateway 112 may be an access gateway operated by an access provider, such as, but not limited to, a mobile network operator and a mobile virtual network operator.

Gateway 112 may have a detecting component 43 operable to detect data 14 (FIG. 1) transmitted from mobile device 102. For example, detecting component 43 may monitor data transmissions sent from mobile device 102 and/or receive data transmissions sent from mobile device 102. In an aspect, detecting component 43 may detect that data 14 is associated with an application-specific connectivity account 20 (FIG. 2), by for example, detecting an application-specific connectivity account ID 28 sent with the data 14. In addition, detecting component 43 may compare the information within or associated with data 14 (e.g., source information and/or the fingerprint) with the parameters of the application-specific connectivity account 20 to aid in determining whether data 14 is associated with the application-specific connectivity account 20.

Gateway 112 may also have a data transfer component 49 operable to allow the transfer of data detected by detecting component 43 to occur. For example, the application-specific connectivity account 20 may include indicia 63 (FIG. 2) that points directly to gateway 108 (e.g., an IP address, a FQDN, or a URL). In an aspect, data transfer component 49 may use the indicia 63 to identify gateway 108 and allow the detected transfer of data 14 from mobile device 102 to gateway 108 to occur.

In an aspect, data transfer component 49 may allow the detected data 14 to continue transmission to gateway 108 when detecting component 43 detects that data 14 is sent to a destination, such as destination ID 53 (FIG. 1) of service provider 110, corresponding to a permitted remote network gateway 108 linked to the application-specific connectivity account 20, data transfer component 49 may allow the detected data transfer to occur.

In addition, when detecting component 43 detects that data 14 is sent from a source, such as an application ID 26 (FIG. 1) for a specific application 18 (FIG. 1), corresponding to a permitted remote network gateway 108 linked to the application-specific connectivity account 20, data transfer component 49 may allow the detected data transfer to occur. Moreover, in an aspect, data 14 may include indicia, such as but not limited to, a fingerprint, a code, a certain bit having a certain value, an identifier, a header, a source identifier that is configured to link data 14 with application 18. Determining component 16 may detect and recognize the indicia of data 14, determine a relationship between the indicia and the application 18, and thereby linking data 14 to application 18.

In another aspect, when the detected data 14 is associated with a generic data connection, data transfer component 49 may cause the detected data 14 to be transmitted using the generic data connection. For example, if the detected data 14 is associated with a generic data connection ID 25 (FIG. 1), data transfer component 49 may cause the transmission of detected data 14 to be attributed to the generic data connection associated with the generic data connection ID 25. For instance, the generic data connection may be internet access controlled by a network gateway operator associated with gateway 112.

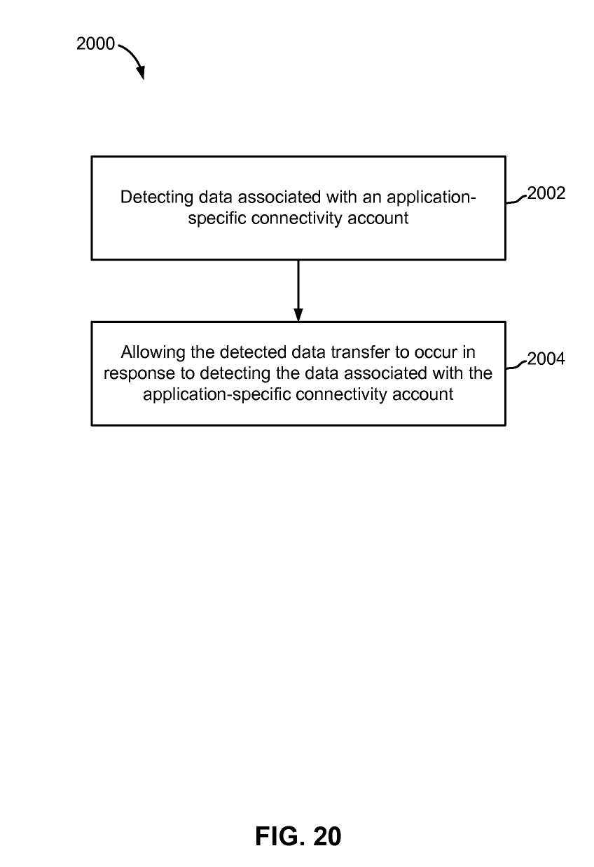

Referring now to FIG. 20, a method 2000 for managing data connectivity in accordance with an aspect includes, at 2002, detecting data associated with an application-specific connectivity account. In an aspect, gateway 112 (FIG. 19) may detect data transmissions sent from mobile device 102 (FIG. 19) that are associated with an application-specific connectivity account. For example, gateway 112 may receive the data transmission sent from mobile device 102 and/or monitor the data transmission sent from mobile device 102. In an aspect, detecting component 43 (FIG. 19) may detect that the data is sent to a destination corresponding to a permitted remote network gateway 108 (FIG. 19) linked to the application-specific connectivity account. In another aspect, detecting component 43 may detect that the data is sent from a source or includes other indicia corresponding to the application-specific connectivity account.

At 2004, the method may also include allowing the detected data transfer to occur in response to detecting the data associated with the application-specific connectivity account. In an aspect, data transfer component 49 (FIG. 19) may allow the detected data to be sent to a remote network gateway 108 that is configured to cause transmission of the data to be attributed to the application-specific connectivity account.

In addition, the method may optionally include receiving additional data and causing the transmission of the additional data. In an aspect, the additional data may include data attributed to a generic connectivity account, such as Internet access provided by and/or controlled by a network gateway operator. For example, gateway 112 may receive additional data and detecting component 43 (FIG. 19) may detect that the data is associated with a generic data connection transmitted by mobile device 102. In addition, gateway 112 may cause the transmission of the additional data to be attributed to the generic data connection associated with the additional data.

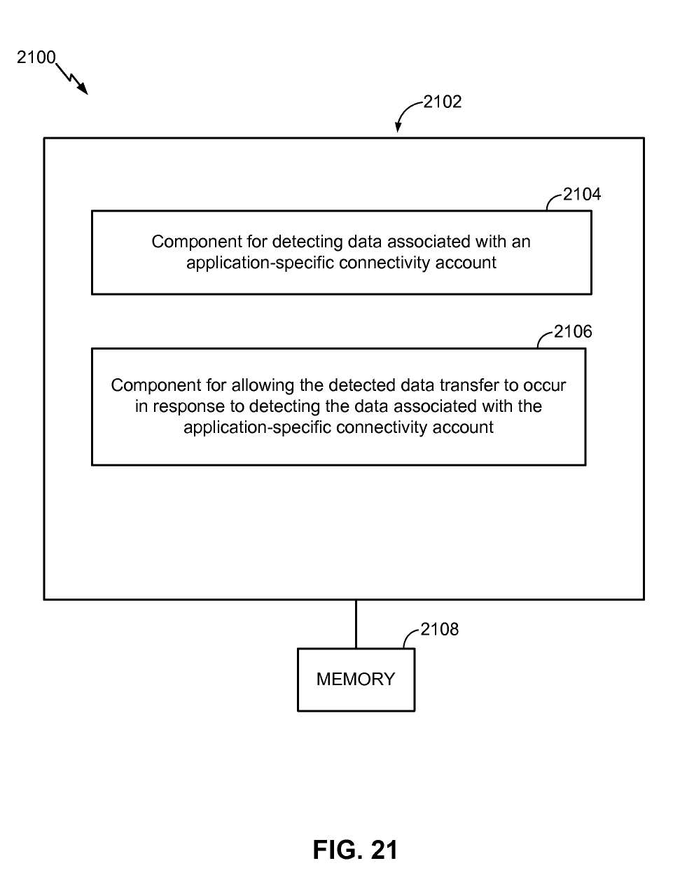

Referring now to FIG. 21, illustrated is a system 2100 configured for data connectivity management. For example, system 2100 can reside at least partially within a transmitter, mobile device, etc. It is to be appreciated that system 2100 is represented as including functional blocks, which can be functional blocks that represent functions implemented by a processor, software, or combination thereof (e.g., firmware). System 2100 includes a logical grouping 2102 of electrical components that facilitate data connectivity management. For instance, logical grouping 2102 may include component 2104 for detecting data associated with an application-specific connectivity account. Further, logical grouping 2102 may comprise component 2106 for allowing the detected data transfer to occur in response to detecting the data associated with the application-specific connectivity account. Additionally, system 2100 can include a memory 2108 that retains instructions for executing functions associated with electrical components 2104 and 2106. While shown as being external to memory 2108, it is to be understood that one or more of electrical components 2104 and 2106 can exist within memory 2108.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method operable by a mobile device, comprising:
detecting data associated with an application-specific connectivity account; and
in response to detecting the data associated with the application-specific connectivity account, sending the data to a remote network gateway configured to cause transmission of the data to be attributed to the application-specific connectivity account.

2. The method as in claim 1, wherein detecting data associated with an application-specific connectivity account comprises detecting that the data is being transmitted by a permitted source application linked to the application-specific connectivity account; and
wherein sending the data to the remote network gateway comprises sending the data to the remote network gateway in response to detecting that the data is being transmitted by a permitted source application linked to the application-specific connectivity account.

3. The method as in claim 1, wherein detecting data associated with an application-specific connectivity account comprises detecting that the data is being transmitted by a permitted mobile device linked to the application-specific connectivity account; and
wherein sending the data to the remote network gateway comprises sending the data to the remote network gateway in response to detecting that the data is being transmitted by a permitted mobile device linked to the application-specific connectivity account.

4. The method as in claim 1, wherein detecting data associated with an application-specific connectivity account comprises detecting that the data is being transmitted by a permitted user linked to the application-specific connectivity account; and
wherein sending the data to the remote network gateway comprises sending the data to the remote network gateway in response to detecting that the data is being transmitted by a permitted user linked to the application-specific connectivity account.

5. The method as in claim 1, wherein detecting data associated with an application-specific connectivity account comprises detecting that the data is being transmitted to a permitted destination linked to the application-specific connectivity account; and
wherein sending the data to the remote network gateway comprises sending the data to the remote network gateway in response to detecting that the data is being transmitted to a permitted destination linked to the application-specific connectivity account.

6. The method as in claim 1, wherein detecting data associated with an application-specific connectivity account comprises detecting that the data is of a data type linked to the application-specific connectivity account; and
wherein sending the data to the remote network gateway comprises sending the data to the remote network gateway in response to detecting that the data is of a data type linked to the application-specific connectivity account.

7. The method as in claim 1, wherein detecting data associated with an application-specific connectivity account comprises detecting that the data includes content linked to the application-specific connectivity account; and
wherein sending the data to the remote network gateway comprises sending the data to the remote network gateway in response to detecting that the data includes content linked to the application-specific connectivity account.

8. The method as in claim 1, wherein detecting data associated with an application-specific connectivity account comprises detecting that the data includes one or more indicia linked to the application-specific connectivity account; and
wherein sending the data to the remote network gateway comprises sending the data to the remote network gateway in response to detecting that the data includes one or more indicia linked to the application-specific connectivity account.

9. The method as in claim 8, wherein the one or more indicia comprises a fingerprint linked to the application-specific connectivity account.

10. The method as in claim 8, wherein the one or more indicia comprises a flag linked to the application-specific connectivity account.

11. The method as in claim 8, wherein the one or more indicia comprises a header linked to the application-specific connectivity account.

12. The method as in claim 8, wherein the one or more indicia comprises a pointer to the remote gateway.

13. The method as in claim 1, wherein the remote network gateway is further configured to receive the data, determine that the data is associated with the application-specific connectivity account, and cause transmission of the data to be attributed to the application-specific connectivity account in response to determining that the data is associated with the application-specific connectivity account.

14. The method as in claim 1, wherein the remote network gateway is further configured to receive additional data and cause transmission of the additional data to be attributed to a generic connectivity account in response to determining that the additional data is not associated with any application-specific connectivity account.

15. The method as in claim 1, further comprising:
detecting an availability of a generic data connection; and
automatically switching from use of an application-specific data connection to use of a generic data connection in response to detecting the availability of the generic data connection.

16. The method of claim 15, wherein the generic data connection is a paid data connection.

17. The method of claim 15, wherein the generic data connection is a free data connection.

18. The method of claim 1, further comprising:
in response to using an application-specific data connection associated with the application-specific connectivity account, altering an operation of an application that sent the detected data.

19. The method of claim 18, wherein altering the operation of the application that sent the detected data comprises one or more of the following:
causing the application to refrain from downloading data;
causing the application to alter a communication frequency; or
causing the application to commence using data compression.

20. At least one processor, comprising:
a first module for detecting data associated with an application-specific connectivity account; and
in response to detecting the data associated with the application-specific connectivity account, a second module for sending the data to a remote network gateway configured to cause transmission of the data to be attributed to the application-specific connectivity account.

21. A computer program product, comprising:
a computer-readable medium comprising:
at least one instruction for causing a computer to detect data associated with an application-specific connectivity account; and
in response to detecting the data associated with the application-specific connectivity account, at least one instruction for causing the computer to send the data to a remote network gateway configured to cause transmission of the data to be attributed to the application-specific connectivity account.

22. An apparatus, comprising:
means for detecting data associated with an application-specific connectivity account; and
in response to detecting the data associated with the application-specific connectivity account, means for sending the data to a remote network gateway configured to cause transmission of the data to be attributed to the application-specific connectivity account.

23. An apparatus, comprising:
a detecting component operable to detect data associated with an application-specific connectivity account; and
a sending component operable to send the data to a remote network gateway configured to cause transmission of the data to be attributed to the application-specific connectivity account in response to detecting the data associated with the application-specific connectivity account.

24. The apparatus as in claim 23, wherein the detecting component is further operable to detect that the data is being transmitted by a permitted source application linked to the application-specific connectivity account; and
wherein the sending component is further operable to send the data to the remote network gateway in response to detecting that the data is being transmitted by a permitted source application linked to the application-specific connectivity account.

25. The apparatus as in claim 23, wherein the detecting component is further operable to detect that the data is being transmitted by a permitted mobile device linked to the application-specific connectivity account; and
wherein the sending component is further operable to send the data to the remote network gateway in response to detecting that the data is being transmitted by a permitted mobile device linked to the application-specific connectivity account.

26. The apparatus as in claim 23, wherein the detecting component is further operable to detect that the data is being transmitted by a permitted user linked to the application-specific connectivity account; and
wherein the sending component is further operable to send the data to the remote network gateway in response to detecting that the data is being transmitted by a permitted user linked to the application-specific connectivity account.

27. The apparatus as in claim 23, wherein the detecting component is further operable to detect that the data is being transmitted to a permitted destination linked to the application-specific connectivity account; and
wherein the sending component is further operable to send the data to the remote network gateway in response to detecting that the data is being transmitted to a permitted destination linked to the application-specific connectivity account.

28. The apparatus as in claim 23, wherein the detecting component is further operable to detect that the data is of a data type linked to the application-specific connectivity account; and
wherein the sending component is further operable to send the data to the remote network gateway in response to detecting that the data is of a data type linked to the application-specific connectivity account.

29. The apparatus as in claim 23, wherein the detecting component is further operable to detect that the data includes content linked to the application-specific connectivity account; and
wherein the sending component is further operable to send the data to the remote network gateway in response to detecting that the data includes content linked to the application-specific connectivity account.

30. The apparatus as in claim 23, wherein the detecting component is further operable to detect that the data includes one or more indicia linked to the application-specific connectivity account; and
wherein the sending component is further operable to send the data to the remote network gateway in response to detecting that the data includes one or more indicia linked to the application-specific connectivity account.

31. The apparatus as in claim 30, wherein the one or more indicia comprises a fingerprint linked to the application-specific connectivity account.

32. The apparatus as in claim 30, wherein the one or more indicia comprises a flag linked to the application-specific connectivity account.

33. The apparatus as in claim 30, wherein the one or more indicia comprises a header linked to the application-specific connectivity account.

34. The apparatus as in claim 30, wherein the one or more indicia comprises a pointer to the remote gateway.

35. The apparatus as in claim 23, wherein the remote network gateway is further configured to receive the data, determine that the data is associated with the application-specific connectivity account, and cause transmission of the data to be attributed to the application-specific connectivity account in response to determining that the data is associated with the application-specific connectivity account.

36. The apparatus as in claim 23, wherein the remote network gateway is further configured to receive additional data and cause transmission of the additional data to be attributed to a generic connectivity account in response to determining that the additional data is not associated with any application-specific connectivity account.

37. The apparatus as in claim 23, further comprising:
the detecting component being further operable to detecting an availability of a generic data connection; and
a switching component operable to automatically switching from use of an application-specific data connection to use of a generic data connection in response to detecting the availability of the generic data connection.

38. The apparatus of claim 37, wherein the generic data connection is a paid data connection.

39. The apparatus of claim 37, wherein the generic data connection is a free data connection.

40. The apparatus as in claim 23, further comprising:
an altering component operable to alter an operation of an application that sent the detected data in response to using an application-specific data connection associated with the application-specific connectivity account.

41. The apparatus of claim 40, wherein altering the operation of the application that sent the detected data comprises one or more of the following:
causing the application to refrain from downloading data;
causing the application to alter a communication frequency; or
causing the application to commence using data compression.

42. A method operable by a network gateway, comprising:
detecting data associated with an application-specific connectivity account; and
in response to detecting the data associated with the application-specific connectivity account, allowing the detected data transfer to occur.

43. The method as in claim 42, where in detecting data associated with an application-specific connectivity account comprises detecting that the data is sent to a destination corresponding to a permitted remote network gateway linked to the application-specific connectivity account.

44. The method as in claim 42, where in detecting data associated with an application-specific connectivity account comprises detecting that the data is sent from a destination corresponding to a permitted remote network gateway linked to the application-specific connectivity account.

45. The method as in claim 42, wherein the network gateway is further configured to receive additional data and cause transmission of the additional data to be attributed to a generic connectivity account in response to determining that the additional data is not associated with any application-specific connectivity account.

46. At least one processor, comprising:
a first module for detecting data associated with an application-specific connectivity account; and
in response to detecting the data associated with the application-specific connectivity account, a second module for allowing the detected data transfer to occur.

47. A computer program product, comprising:
a computer-readable medium comprising:
at least one instruction for causing a computer to detect data associated with an application-specific connectivity account; and
in response to detecting the data associated with the application-specific connectivity account, at least one instruction for causing the computer to allow the detected data transfer to occur.

48. An apparatus, comprising:
means for detecting data associated with an application-specific connectivity account; and
in response to detecting the data associated with the application-specific connectivity account, means for allowing the detected data transfer to occur.

49. An apparatus, comprising:
a detecting component operable to detect data associated with an application-specific connectivity account; and
a data transfer component operable to allow the detected data transfer to occur in response to detecting the data associated with the application-specific connectivity account.

50. The apparatus as in claim 49, where the detecting component is further operable to detect that the data is sent to a destination corresponding to a permitted remote network gateway linked to the application-specific connectivity account.

51. The apparatus as in claim 49, where the detecting component is further operable to detect that the data is sent from a destination corresponding to a permitted remote network gateway linked to the application-specific connectivity account.

52. The apparatus as in claim 49, wherein the detecting component is further operable to receive additional data; and
wherein the data transfer component is further operable to cause transmission of the additional data to be attributed to a generic connectivity account in response to determining that the additional data is not associated with any application-specific connectivity account.

53. A method of network communication, comprising:
detecting an occurrence of an event, the detected event comprising a non-permitted use of the application-specific data connection; and
preventing further transmission of the data via the application-specific data connection based on the occurrence of the detected event.

54. The method of claim 53, wherein the detected event comprises use of the application-specific data connection to contact a destination that is not included in a set of approved destinations for the service-specific data connection.

55. The method of claim 53, wherein the detected event comprises use of the application-specific data connection to transmit data without a fingerprint of the data being matched to one of a set of approved fingerprints.

56. The method of claim 53, wherein the detected event comprises a data exchange over the application-specific data connection in excess of an expected data usage amount for typical data traffic of the application.

57. At least one processor, comprising:
a first module for detecting an occurrence of an event, the detected event comprising a non-permitted use of the application-specific data connection; and
a second module for preventing further transmission of the data via the application-specific data connection based on the occurrence of the detected event.

58. A computer program product, comprising:
a computer-readable medium comprising:
at least one instruction for causing a computer to detect an occurrence of an event, the detected event comprising a non-permitted use of the application-specific data connection; and
at least one instruction for causing the computer to prevent further transmission of the data via the application-specific data connection based on the occurrence of the detected event.

59. An apparatus, comprising:
means for detecting an occurrence of an event, the detected event comprising a non-permitted use of the application-specific data connection; and
means for preventing further transmission of the data via the application-specific data connection based on the occurrence of the detected event.

60. An apparatus, comprising:
a data plan monitoring component operable to detect an occurrence of an event, the detected event comprising a non-permitted use of the application-specific data connection; and
a transmission component operable to prevent further transmission of the data via the application-specific data connection based on the occurrence of the detected event.

61. The apparatus of claim 60, wherein the detected event comprises use of the application-specific data connection to contact a destination that is not included in a set of approved destinations for the service-specific data connection.

62. The apparatus of claim 60, wherein the detected event comprises use of the application-specific data connection to transmit data without a fingerprint of the data being matched to one of a set of approved fingerprints.

63. The apparatus of claim 60, wherein the detected event comprises a data exchange over the application-specific data connection in excess of an expected data usage amount for typical data traffic of the application.

64. A method of network communication, comprising:
exchanging application data over a sponsored application-specific data connection; and
triggering an incentive for the exchange of the application data via the sponsored application-specific data connection.

65. At least one processor, comprising:
a first module for exchanging application data over a sponsored application-specific data connection; and
a second module for triggering an incentive for the exchange of the application data via the sponsored application-specific data connection.

66. A computer program product, comprising:
a computer-readable medium comprising:
at least one instruction for causing a computer to exchange application data over a sponsored application-specific data connection; and
at least one instruction for causing the computer to trigger an incentive for the exchange of the application data via the sponsored application-specific data connection.

67. An apparatus, comprising:
means for exchanging application data over a sponsored application-specific data connection; and
means for triggering an incentive for the exchange of the application data via the sponsored application-specific data connection.

68. An apparatus, comprising:
a sending component operable to exchange application data over a sponsored application-specific data connection; and
an incentive component operable to trigger an incentive for the exchange of the application data via the sponsored application-specific data connection.

69. A method for managing data connectivity, the method comprising:
automatically switching between a use of an application-specific data connection and a use of a generic data connection for transmitting data.

70. The method of claim 69, wherein the automatically switching further comprises:
switching from the use of the application-specific data connection to the use of the generic data connection to transmit the data.

71. The method of claim 69, further comprising:
detecting an availability of the generic data connection; and
in response to detecting the availability of the generic data connection, automatically switching from the application-specific data connection to the generic data connection to transmit the data.

72. The method of claim 69, further comprising:
detecting a reduction in a quality of the generic data connection; and
in response to detecting the reduction in the quality of the generic data connection, automatically switching from the generic data connection to the service-specific data connection.

73. The method of claim 69, wherein the generic data connection is a paid data connection.

74. The method of claim 69, wherein the generic data connection is a free data connection.

75. The method of claim 69, wherein the generic data connection is a generic paid data connection, and wherein automatically switching further comprises:
automatically switching from the use of the generic paid data connection to the use of the application-specific data connection based on a reduction of a data usage balance linked to the generic paid data connection.

76. At least one processor, comprising:
a first module for automatically switching between a use of an application-specific data connection and a use of a generic data connection for transmitting data.

77. A computer program product, comprising:
a computer-readable medium comprising:
at least one instruction for causing a computer to switch between a use of an application-specific data connection and a use of a generic data connection for transmitting data.

78. An apparatus, comprising:
means for automatically switching between a use of an application-specific data connection and a use of a generic data connection for transmitting data.

79. An apparatus, comprising:
a switching component operable to automatically switch between a use of an application-specific data connection and a use of a generic data connection for transmitting data.

80. The apparatus of claim 79, wherein the switching component is further configured to switch from the use of the application-specific data connection to the use of the generic data connection to transmit the data.

81. The apparatus of claim 79, further comprising:
a detecting component operable to detect an availability of the generic data connection; and
in response to detecting the availability of the generic data connection, the switching component is further configured to automatically switch from the application-specific data connection to the generic data connection to transmit the data.

82. The apparatus of claim 79, further comprising:
a detecting component operable to detect a reduction in a quality of the generic data connection; and
in response to detecting the reduction in the quality of the generic data connection, the switching component is further configured to automatically switch from the generic data connection to the service-specific data connection.

83. The apparatus of claim 79, wherein the generic data connection is a paid data connection.

84. The apparatus of claim 79, wherein the generic data connection is a free data connection.

85. The apparatus of claim 79, wherein the generic data connection is a generic paid data connection, and
wherein the switching component is further configured to automatically switch from the use of the generic paid data connection to the use of the application-specific data connection based on a reduction of a data usage balance linked to the generic paid data connection.

86. A method of network communication, comprising:
receiving, at a network device, data transmitted from a mobile device as a result of the mobile device sending the data based on the data being associated with an application-specific connectivity account;
retrieving a data usage account associated with the mobile device, wherein the data usage account includes a data usage threshold; and
processing the received data based on the data usage threshold.

87. The method of claim 86, wherein the data usage threshold comprises an available data usage balance, and wherein processing the received data further comprises decrementing the available data usage balance based on the received data.

88. The method of claim 86, further comprising:
adding a new data usage amount to the data usage account when the available data usage balance reaches a balance level threshold.

89. The method of claim 86, wherein processing the received data further comprises metering a forwarding of the received data.

90. At least one processor, comprising:
a first module for receiving, at a network device, data transmitted from a mobile device as a result of the mobile device sending the data based on the data being associated with an application-specific connectivity account;
a second module for retrieving a data usage account associated with the mobile device, wherein the data usage account includes a data usage threshold; and
a third module for processing the received data based on the data usage threshold.

91. A computer program product, comprising:
a computer-readable medium comprising:
at least one instruction for causing a computer to receive, at a network device, data transmitted from a mobile device as a result of the mobile device sending the data based on the data being associated with an application-specific connectivity account;
at least one instruction for causing the computer to retrieve a data usage account associated with the mobile device, wherein the data usage account includes a data usage threshold; and
at least one instruction for causing the computer to process the received data based on the data usage threshold.

92. An apparatus, comprising:
means for receiving, at a network device, data transmitted from a mobile device as a result of the mobile device sending the data based on the data being associated with an application-specific connectivity account;
means for retrieving a data usage account associated with the mobile device, wherein the data usage account includes a data usage threshold; and
means for processing the received data based on the data usage threshold.

93. An apparatus, comprising:
a receiving component operable to receive data transmitted from a mobile device as a result of the mobile device sending the data based on the data being associated with an application-specific connectivity account;
a data usage account component operable to retrieve a data usage account associated with the mobile device, wherein the data usage account includes a data usage threshold; and
a metering component operable to process the received data based on the data usage threshold.

94. The apparatus of claim 93, wherein the data usage threshold comprises an available data usage balance, and wherein processing the received data further comprises decrementing the available data usage balance based on the received data.

95. The apparatus of claim 93, further comprising:
an balance adjustment component operable to add a new data usage amount to the data usage account when the available data usage balance reaches a balance level threshold.

96. The apparatus of claim 93, wherein the metering component is further configured to meter a forwarding of the received data.
